(19) United States
(12) Patent Application Publication
(10) Pub. No.: US 2025/0111626 A1
(43) Pub. Date: Apr. 3, 2025

(54) PRESENTING CONTENT ASSOCIATED WITH A REAL-WORLD USER INTERFACE

(71) Applicant: Apple Inc., Cupertino, CA (US)

(72) Inventors: Luis R. DELIZ CENTENO, Fremont, CA (US); Devin W. CHALMERS, Oakland, CA (US); Thomas G. SALTER, San Francisco, CA (US); Michael J. ROCKWELL, Palo Alto, CA (US); Christopher I. WORD, San Francisco, CA (US); Jeffrey S. NORRIS, Saratoga, CA (US)

(21) Appl. No.: 18/893,765

(22) Filed: Sep. 23, 2024

Related U.S. Application Data
(60) Provisional application No. 63/586,169, filed on Sep. 28, 2023.

(51) Int. Cl. G06T 19/00; G02B 27/00; G06F 3/01

(52) U.S. Cl. CPC G06T 19/006; G02B 27/0093; G06F 3/017

(57) ABSTRACT

Some examples of the disclosure are directed to systems and methods for presenting content associated with a real-world user interface in an environment. A user interface of a first object in a physical environment can be detected by an electronic device. In some examples, in response to detecting the user interface of the first object, in accordance with one or more criteria being satisfied, the electronic device presents content associated with the user interface of the first object in the environment independent of a location of the first object in the physical environment. In some examples, the content associated with the user interface of the first object includes a timer. In some examples, the content associated with the user interface of the first object includes information corresponding to video content. The environment is optionally a computer-generated environment, and the electronic device optionally includes a head-mounted display.

### CROSS-REFERENCE TO RELATED APPLICATIONS

This application claims benefit of U.S. Provisional Application No. 63/586,169, filed Sep. 28, 2023, the entire disclosure of which is herein incorporated by reference for all purposes.

### FIELD OF THE DISCLOSURE

This relates generally to systems and methods for presenting content in an environment.

### BACKGROUND OF THE DISCLOSURE

Some computer graphical environments provide two-dimensional and/or three-dimensional environments where at least some objects displayed for a user's viewing are virtual and generated by a computer. For example, virtual objects are viewable in environments concurrently with one or more objects of a physical environment.

### SUMMARY OF THE DISCLOSURE

Some examples of the disclosure are directed to systems and methods for presenting content in an environment that is associated with a user interface of a physical object in a physical environment. In some examples, at an electronic device in communication with one or more displays and one or more input devices, the electronic device detects, via the one or more input devices, a user interface of a first object in a physical environment of a user of the electronic device. In some examples, in response to detecting the user interface of the first object and in accordance with a determination that one or more first criteria are satisfied, the electronic device presents, via the one or more displays, first content associated with the user interface of the first object in an environment independent of a location of the first object in the physical environment. In some examples, the environment is a three-dimensional environment, and the first content corresponds to virtual and/or computer-generated objects that are associated with the user interface of the first object.

In some examples, the first content includes one or more virtual representations that are presented in a region of the environment that is independent of a location of the first object relative to the current viewpoint of the user. For example, the first content is presented at a location in the environment that does not correspond to a location of the first object in the environment. For example, the first content is presented in the environment when the user interface of the first object is not included in the current field-of-view of the user. For example, the first content is presented in the environment when the user interface of the first object is outside of a threshold distance from a location corresponding to the current viewpoint of the user.

In some examples, the one or more first criteria include a criterion that is satisfied when the intent of the user of the electronic device is to interact with the user interface of the first object. For example, the electronic device detects interaction of the user with the user interface of the first object when the electronic device detects the user interface of the first object. For example, the electronic device detects attention of the user that is directed to the user interface of the first object. For example, the electronic device detects physical interaction of the user with the user interface of the first object in the physical environment. For example, the electronic device detects user interaction with a virtual element that is presented in the environment. In some examples, the one or more first criteria include a criterion that is satisfied when one or more settings associated with the first content stored in a user profile have a first status. For example, the user profile is associated with the user of the electronic device. In some examples, the one or more first criteria include a criterion that is satisfied when a mode of operation of the electronic device is currently active. For example, the mode of operation is for presenting content in the environment that is associated with user interfaces of objects in the physical environment. For example, the mode of operation is associated with an application that is accessible by the user of the electronic device.

In some examples, the user interface of the first object displays a timer set to a first time interval, and the first content includes a timer set to the first time interval. For example, the timer included in the first content corresponds to the timer displayed by the user interface of the first object. In some examples, the user interface of the first object includes video content that is displayed by a physical display in the physical environment, and the first content includes information corresponding to the video content. For example, the first content includes metadata that is associated with the video content. In some examples, the user interface of the first object includes video content, and the first content includes supplemental content associated with the video content. For example, the supplemental content includes subtitles and/or supplemental information associated with the video content. For example, the subtitles and/or supplemental information are not displayed by the physical display of the first object in the physical environment. In some examples, presenting the first content includes providing an audio output and/or presenting a picture-in-picture view of video content in the environment.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a device according to some examples of the disclosure.

FIGS. 3A-3F illustrate an electronic device presenting content in an environment that corresponds to a user interface of an object in a physical environment, according to some examples of the disclosure.

FIGS. 4A-4J illustrate an electronic device presenting content in an environment that corresponds to a user interface of an object in a physical environment, according to some examples of the disclosure.

FIG. 5 illustrates a flow diagram illustrating an example process for presenting content in an environment that is associated with a user interface of an object in a physical environment, according to some examples of the disclosure.

### DETAILED DESCRIPTION

Some examples of the disclosure are directed to systems and methods for presenting content in an environment that is associated with a user interface of an object in a physical environment. In some examples, at an electronic device in communication with one or more displays and one or more input devices, the electronic device detects, via the one or more input devices, a user interface of a first object in a physical environment of a user of the electronic device. In some examples, in response to detecting the user interface of the first object and in accordance with a determination that one or more first criteria are satisfied, the electronic device presents, via the one or more displays, first content associated with the user interface of the first object in an environment independent of a location of the first object in the physical environment. In some examples, the environment is a three-dimensional environment, and the first content corresponds to virtual and/or computer-generated objects that are associated with the user interface of the first object.

In some examples, the first content includes one or more virtual representations that are presented in a region of the environment that is independent of a location of the first object relative to the current viewpoint of the user. For example, the first content is presented at a location in the environment that does not correspond to a location of the first object in the environment. For example, the first content is presented in the environment when the user interface of the first object is not included in the current field-of-view of the user. For example, the first content is presented in the environment when the user interface of the first object is outside of a threshold distance from a location corresponding to the current viewpoint of the user.

In some examples, the one or more first criteria include a criterion that is satisfied when the intent of the user of the electronic device is to interact with the user interface of the first object. For example, the electronic device detects interaction of the user with the user interface of the first object when the electronic device detects the user interface of the first object. For example, the electronic device detects attention of the user that is directed to the user interface of the first object. For example, the electronic device detects physical interaction of the user with the user interface of the first object in the physical environment. For example, the electronic device detects user interaction with a virtual element that is presented in the environment. In some examples, the one or more first criteria include a criterion that is satisfied when one or more settings associated with the first content stored in a user profile have a first status. For example, the user profile is associated with the user of the electronic device. In some examples, the one or more first criteria include a criterion that is satisfied when a mode of operation of the electronic device is currently active. For example, the mode of operation is for presenting content in the environment that is associated with user interfaces of objects in the physical environment. For example, the mode of operation is associated with an application that is accessible by the user of the electronic device.

In some examples, the user interface of the first object displays a timer set to a first time interval, and the first content includes a timer set to the first time interval. For example, the timer included in the first content corresponds to the timer displayed by the user interface of the first object. In some examples, the user interface of the first object includes video content that is displayed by a physical display in the physical environment, and the first content includes information corresponding to the video content. For example, the first content includes metadata that is associated with the video content. In some examples, the user interface of the first object includes video content, and the first content includes supplemental content associated with the video content. For example, the supplemental content includes subtitles and/or supplemental information associated with the video content. For example, the subtitles and/or supplemental information are not displayed by the physical display of the first object in the physical environment. In some examples, presenting the first content includes providing an audio output and/or presenting a picture-in-picture view of video content in the environment.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

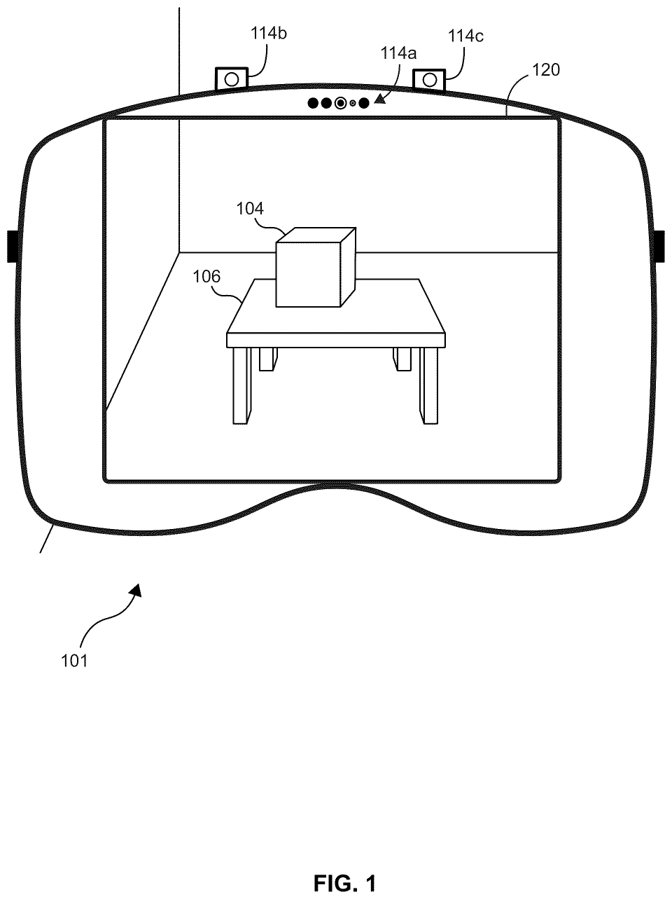

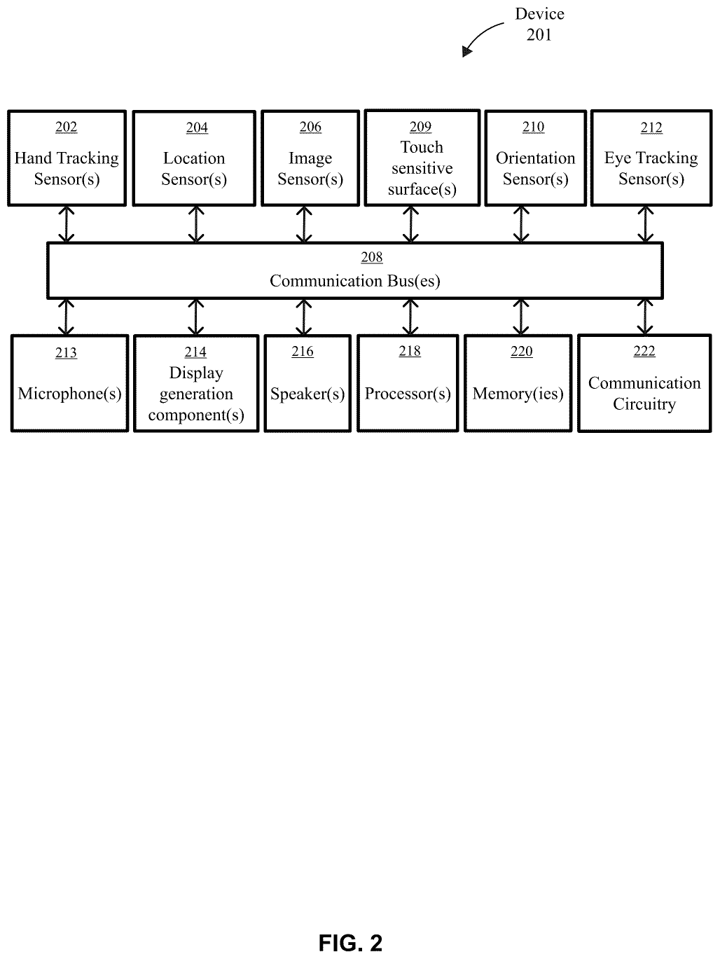

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television (TV) channel browsing application, and/or a digital video player application.

FIG. 2 illustrates a block diagram of an example architecture for a device 201 according to some examples of the disclosure. In some examples, device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more speakers 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards interactions including one or more virtual objects that are displayed in an environment presented at an electronic device (e.g., corresponding to electronic device 201). In some examples, an electronic device presents content in an environment associated with a user interface included in a physical environment of a user of the electronic device.

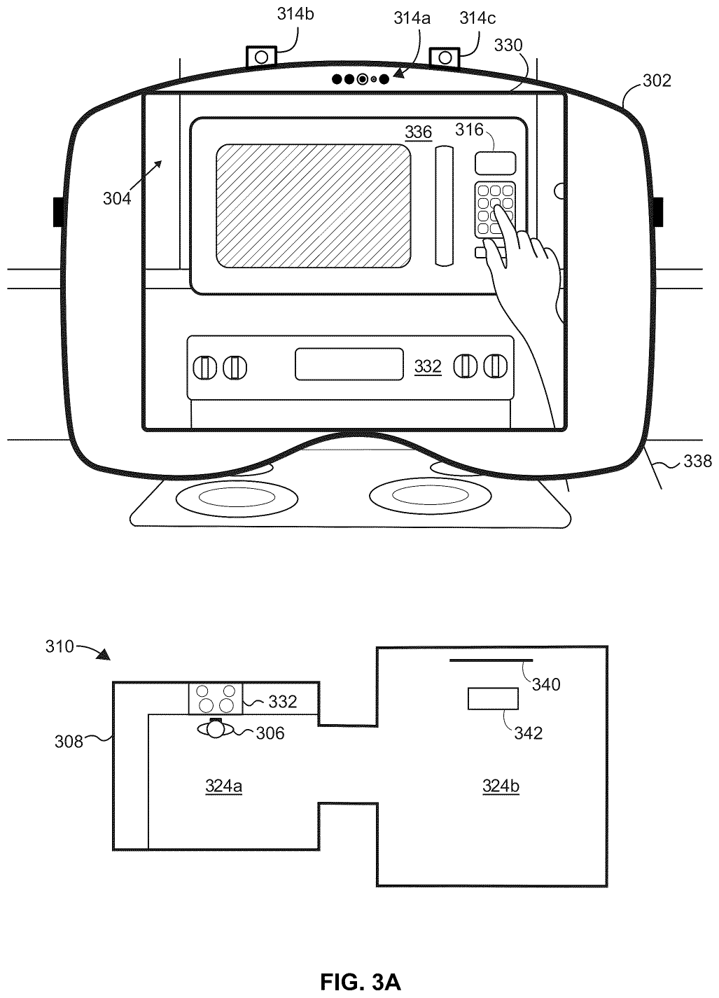

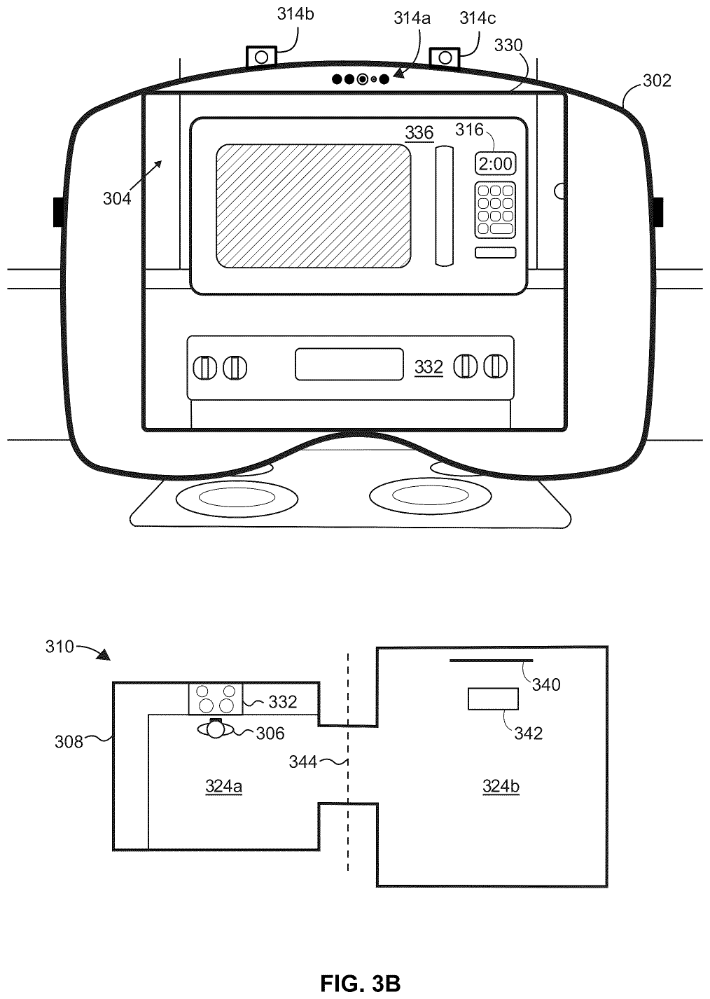

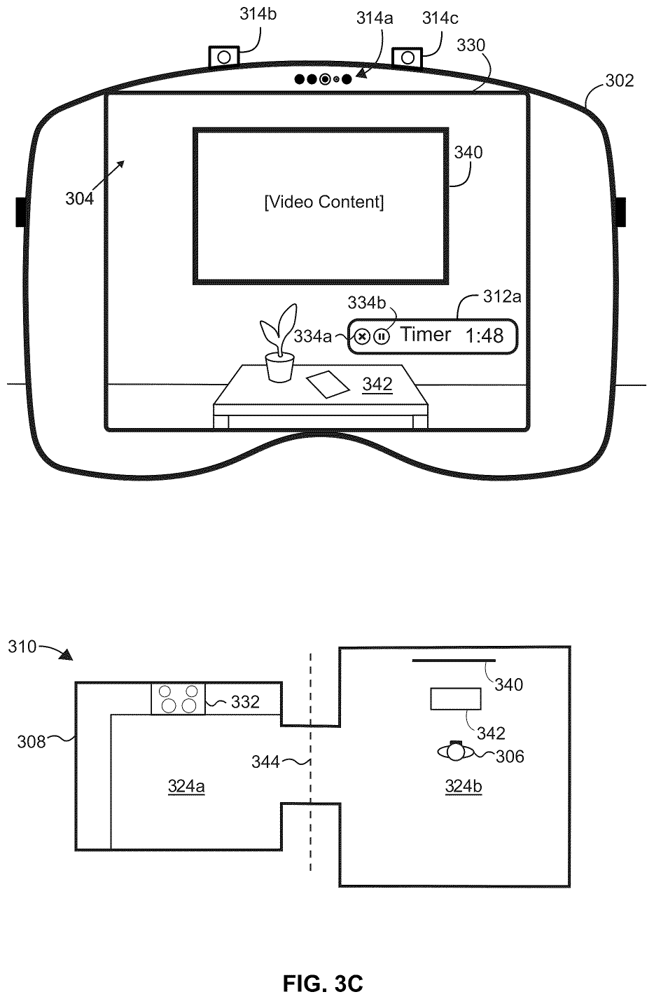

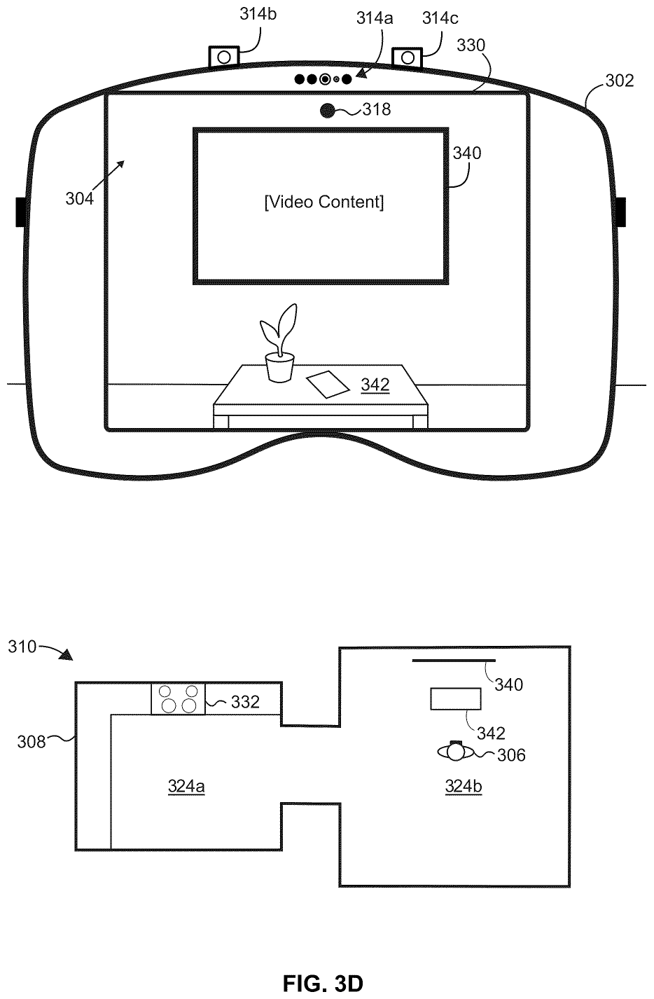

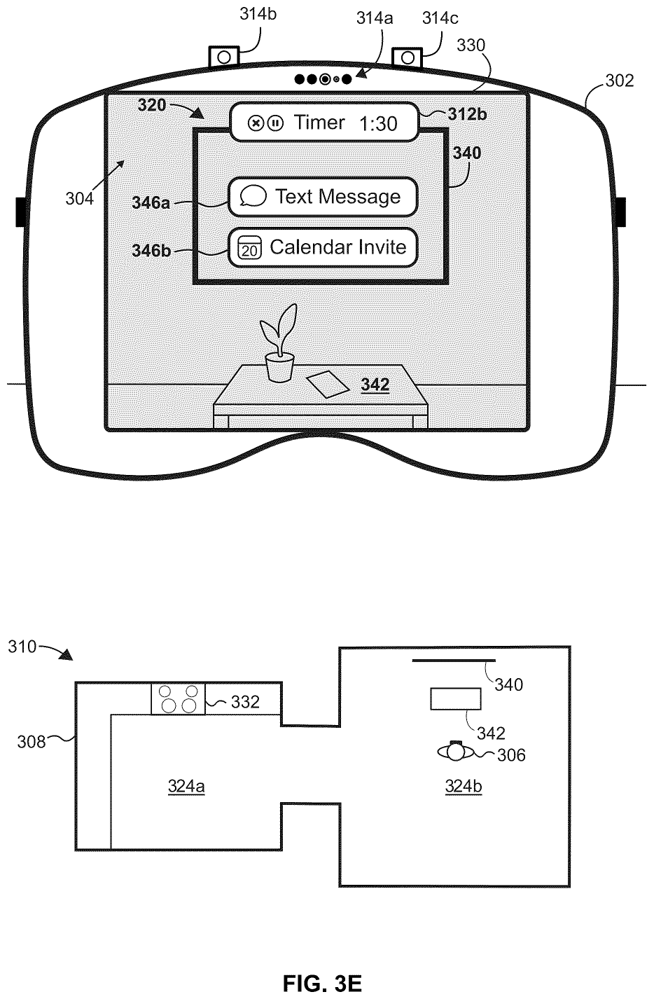

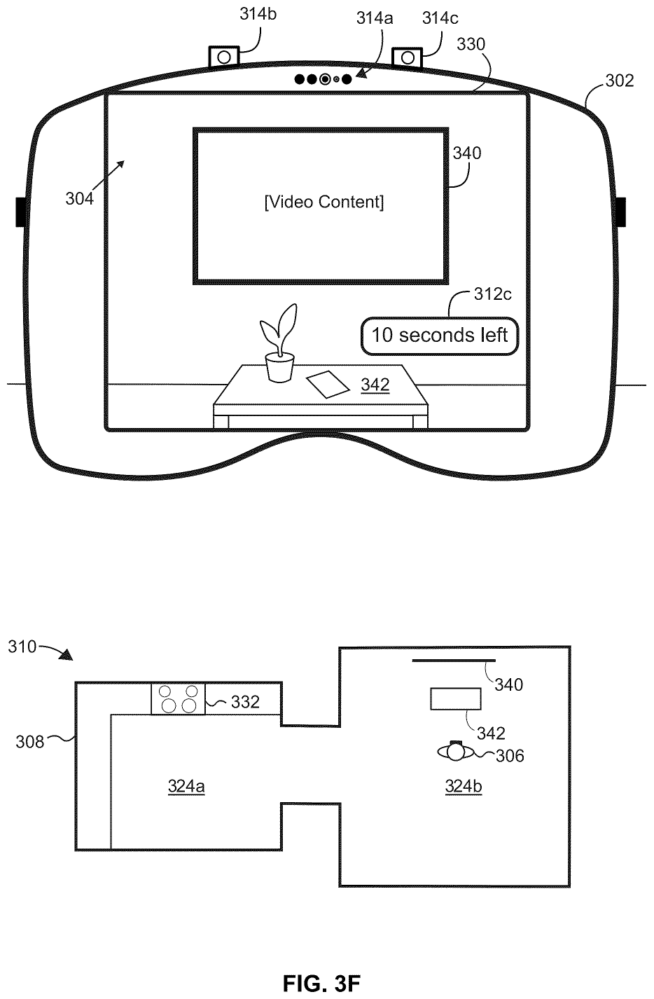

FIGS. 3A-3F illustrate an electronic device presenting content in an environment that corresponds to a user interface of a real-world object (e.g., and object included in a physical environment), according to some examples of the disclosure. In some examples, the content includes a virtual representation that corresponds to a timer shown by the user interface (e.g., including content displayed on a display) of the real-world object. In some examples, electronic device 302 shown in FIGS. 3A-3F has one or more characteristics of electronic device 101 and/or electronic device 201 as described above. In some examples, as shown in FIGS. 3A-3F, electronic device 302 is a head-mounted display that includes a display generation component 330 (e.g., or optionally one or more display generation components that have one or more characteristics of display generation component(s) 214 as described above) that presents an environment 304 to user 306 (e.g., using a transparent or translucent display). In some examples, electronic device 302 includes one or more image sensors 314a-314c (e.g., including one or more characteristics of image sensors 114a-114c and/or image sensor(s) 206 as described above) configured to detect physical environment 308 (e.g., as shown in overhead view 310) and/or movements of one or more portions of user 306 (e.g., hands, head and/or eyes) and/or attention (e.g., head orientation, gaze) of user 306. Physical environment 308 has one or more characteristics of a real-world environment and/or a physical environment described above.

In some examples, environment 304 is a three-dimensional environment that is presented to user 306 through display generation component 330 of electronic device 302. In some examples, environment 304 is an extended reality (XR) environment having one or more characteristics of an XR environment described above. For example, from a current viewpoint of user 306, one or more virtual objects (e.g., virtual representation 312a shown and described with reference to FIG. 3C) and/or one or more physical objects (e.g., real-world table 106 as shown and described with reference to FIG. 1 and/or real-world microwave 336 shown and described with reference to FIG. 3A) in physical environment 308 are visible (e.g., through video passthrough or optical see-through of physical environment 308 that is visible to user 306 through display generation component 330). In some examples, environment 304 is a virtual reality environment (e.g., environment 304 is fully or partially immersive (e.g., user 306 controls a level of virtual immersion through one or more input devices of electronic device 302)).

FIG. 3A illustrates electronic device 302 detecting a user interface of an object in physical environment 308. In some examples, the user interface of the object is visible to user 306 through display generation component 330. In some examples, electronic device 302 detects a real-world user interface 316 of a real-world microwave 336. As shown in FIG. 3A, additional objects included in physical environment 308 are visible to user 306 (e.g., through display generation component 330) in environment 304 (e.g., through video passthrough or optical see-through). For example, a real-world stove 332, which is included in physical environment 308, is visible in environment 304 from the current viewpoint of user 306. In some examples, real-world user interface 316 includes a touchpad and/or display of real-world microwave 336 that user 306 uses to input a desired cooking time or view a timer indicating progress of the cooking time.

FIGS. 3A-3F also illustrate an overhead view 310 of physical environment 308 (e.g., including user 306). In some examples, physical environment 308 is an indoor space that includes a plurality of rooms. For example, as shown in overhead view 310, physical environment 308 includes a first room 324a (e.g., a kitchen) and a second room 324b (e.g., a living room). As shown in overhead view 310, first room 324a includes real-world microwave 336 and real-world stove 332. In some examples, physical environment 308 is an indoor and/or an outdoor space including a plurality of physical objects (e.g., indoor furniture, appliances, doors, walls, floors, outdoor furniture, outdoor structures and/or natural objects) that are visible to user 306 (e.g., through display generation component 330) in environment 304 through video passthrough and/or optical see-though. In some examples, one or more virtual objects (e.g., such as virtual representations 312a-312bc shown and described with reference to FIGS. 3C, 3E, and 3F) are presented in environment 304 and are visible to user 306 (e.g., through display generation component 330) concurrently with the plurality of physical objects included in physical environment 308. In some examples, movement of user 306 in physical environment 308 corresponds to movement of the current viewpoint of user 306 relative to environment 304. For example, movement of user 306 in physical environment 308 (e.g., caused by physical movement of user 306) from first room 324a to second room 324b corresponds to movement of the current viewpoint of user 306 relative to environment 304 from a first region of environment 304 associated with first room 324a to a second region of environment 304 associated with second room 324b. In some examples, movement of the current viewpoint of user 306 relative to environment 304 causes one or more virtual objects presented at a world-locked orientation in the first region of environment 304 to no longer be visible to user 306. In some examples, movement of the current viewpoint of user 306 relative to environment 304 causes a view of one or more physical objects included in physical environment 308 to change while a view of one or more virtual objects presented in environment 304 at a body-locked or head-locked orientation to be maintained from the current viewpoint of user 306.

In some examples, electronic device 302 detects interaction of user 306 with real-world microwave 336 and/or real-world user interface 316 while detecting real-world microwave 336 and/or real-world user interface 316. For example, electronic device 302 optionally detects real-world user interface 316 and/or the user interaction with real-world user interface 316 using image sensors 314a-314c. In some examples, detecting the interaction of user 306 with real-world microwave 336 and/or real-world user interface 316 includes detecting hand 338 of user 306 providing input to real-world user interface 316 and/or a change in appearance of real-world user interface 316 (e.g., a change in the time interval displayed by real-world user interface 316 based on the input provided by user 306). In some examples, information associated with the interaction of user 306 with real-world user interface 316 is stored by electronic device 302 in a memory (e.g., having one or more characteristics of memory 220 shown and described with reference to FIG. 2). For example, the information associated with the interaction of user 306 with real-world user interface 316 is used to present content in environment 304 associated with real-world user interface 316 (e.g., as described below).

FIG. 3B illustrates real-world user interface 316 with an updated appearance based on the input provided by user 306 in FIG. 3A. Particularly, a two-minute timer is set on real-world microwave 336 based on the user input. In some examples, (e.g., using image sensors 314a-314c). In some examples, electronic device 302 detects further interaction of user 306 with real-world user interface 316 (e.g., user 306 presses a start button on real-world user interface 316 to start real-world microwave 336). In some examples, electronic device 302 optionally detects changes in the appearance of real-world user interface 316 (e.g., using image sensors 314a-314c). For example, while detecting the interaction of user 306 with real-world user interface 316 (e.g., as shown and described with reference to FIG. 3A), electronic device 302 detects the display of real-world user interface 316 changing based on the interaction (e.g., electronic device 302 detects one or more numbers being added to real-world user interface 316 (e.g., associated with the selected time-interval)). For example, after detecting the interaction of user 306 with real-world user interface 316, electronic device 302 optionally detects the time-interval that is displayed by real-world user interface 316. For example, after detecting the interaction of user 306 with real-world user interface 316, electronic device 302 detects the time-interval displayed by real-world user interface 316 changing (e.g., corresponding to sequential countdown of the two-minute timer). In some examples, electronic device 302 stores information (e.g., in a memory) associated with the user interaction with, the updated appearance of, and/or the changed appearance of real-world user interface 316. For example, electronic device 302 stores information corresponding to the time-interval that is displayed by real-world user interface 316. In some examples, the time-interval (e.g., and/or the change in the time-interval displayed by real-world user interface 316) is used to present a virtual representation in environment 304 (e.g., as shown and described with reference to FIG. 3C).

In some examples, electronic device 302 presents virtual content associated with real-world user interface 316 in environment 304 in accordance with one or more criteria being satisfied. For example, electronic device 302 utilizes the one or more criteria to determine if virtual content associated with real-world user interface 316 should be presented in environment 304. Presenting content associated with real-world user interface 316 in environment 304 when the one or more criteria are satisfied ensures that the content is presented in environment 304 when user 306 intends and/or desires the content to be presented in environment 304. For example, the one or more criteria include a criterion that is satisfied when electronic device 302 detects user interaction with real-world user interface 316 (e.g., as shown and described with reference to FIG. 3A). For example, the one or more criteria include a criterion that is satisfied when electronic device 302 detects a visual appearance of real-world user interface 316 (e.g., a time-interval and/or a countdown of a timer that is displayed by real-world user interface 316 (e.g., optionally after detecting user interaction with real-world user interface 316)). For example, the one or more criteria include a criterion that is satisfied when electronic device 302 detects intent of user 306 to interact (e.g., to further interact) with real-world user interface 316. For example, electronic device 302 detects the intent of user 306 to interact with real-world user interface 316 based on attention of user 306 that is directed (e.g., for a threshold period of time (e.g., 0.1, 0.2, 0.5, 1, 2, 5 or 10 seconds) to real-world user interface 316 (e.g., electronic device 302 detects an orientation of electronic device 302 and/or gaze of user 306 (e.g., using one or more eye tracking sensors having one or more characteristics of eye tracking sensor(s) 212 shown and described with reference to FIG. 2)).

In some examples, the one or more criteria includes a criterion that is satisfied when electronic device 302 is operated in a mode of operation prior to and/or during the detection of real-world user interface 316 (e.g., prior to and/or during the interaction of user 306 with real-world user interface 316). Establishing a criterion for presenting content associated with real-world user interfaces in environment 304 that includes operating electronic device 302 in a mode of operation provides user 306 discretion in deciding when electronic device 302 should present content in environment 304 associated with one or more real-world user interfaces. In some examples, the mode of operation is associated with an application that is accessible by user 306 (e.g., through electronic device 302). For example, electronic device 302 is operated in the mode of operation when an application is launched (e.g., the application is launched by user 306 prior to the interaction with real-world user interface 316 shown in FIG. 3A). In some examples, the application is associated with presenting content in environment 304 that is associated with one or more real-world objects (e.g., and/or one or more real-world user interfaces of the one or more real-world objects). For example, operating electronic device 302 in the mode of operation prompts electronic device 302 to detect one or more user interfaces (e.g., real-world user interface 316) and present content in environment 304 associated with the one or more user interfaces. In some examples, if electronic device 302 is not operated in the mode of operation prior to and/or while user 306 interacts with real-world user interface 316 (e.g., as shown and described with reference to FIG. 3A), electronic device 302 forgoes presenting content in environment 304 associated with real-world user interface 316.

In some examples, the one or more criteria include a criterion that is satisfied when one or more settings stored in a user profile of user 306 have a first status. For example, the user profile includes one or more settings for presenting (or not presenting) content in environment 304 that is associated with one or more objects (e.g., or one or more user interfaces of the one or more objects) in physical environment 308. For example, the one or more settings include a setting for presenting content in environment 304 associated with cooking (e.g., if the setting is a first status, electronic device 302 presents the content associated with real-world user interface 316, and if the setting is a second status different from the first status, electronic device 302 forgoes presenting the content associated with real-world user interface 316).

In some examples, in accordance with the one or more criteria being satisfied, the electronic device 302 presents the content associated with real-world user interface 316 in environment 304. In some examples, the content associated with real-world user interface 316 is presented at a location that is different from (e.g., independent of) a location of real-world microwave 336 and/or user interface 316. For example, the content is not presented at a location in environment 304 corresponding to a location of real-world microwave 336 and/or user interface 316. In some examples, the content associated with the real-world user interface 316 is initially presented at a location of the real-world user interface 316 and then is shifted to a different location (e.g., optionally using an animation). In some examples, the content is displayed at a predetermined location, such as in a corner or along an edge of the display (e.g., center of top edge, bottom right corner, etc.). In some examples, the content is presented at a body-locked and/or head-locked orientation in environment 304 from the current viewpoint of user 306 (e.g., the content maintains in view during a change in viewpoint of user 306 relative to environment 304).

In some examples, presenting the content associated with real-world user interface 316 in environment 304 includes adding the content associated with real-world user interface 316 to a user interface that is accessible to user 306 through environment 304 (e.g., such as system user interface 320 shown and described with reference to FIG. 3E). For example, in response to the one or more criteria being satisfied, the electronic device 302 adds the content to a system user interface that is accessible through user input and forgoes presenting the content through one or more virtual representations (e.g., such as virtual representation 312a shown and described with reference to FIG. 3C) in environment 304 from the current viewpoint of user 306. In some examples, electronic device 302 adds the content to the system user interface in addition to presenting the content through one or more virtual representations in environment 304. In some examples, electronic device 302 determines whether to present the content through one or more virtual representations in environment 304 (e.g., in addition to adding the content to the system user interface) based on one or more determinations made by electronic device 302 (e.g., such as based on the position of the current viewpoint of user 306 as described below).

In some examples, presenting the content associated with real-world user interface 316 in environment 304 includes presenting one or more virtual representations (e.g., virtual representation 312a shown and described with reference to FIG. 3C) in environment 304. In some examples, in accordance with the one or more criteria for presenting the content associated with real-world user interface 316 in environment 304 being satisfied, the electronic device determines whether to present the one or more virtual representations in environment 304 from the current viewpoint of the user. In some examples, electronic device 302 determines whether to present the one or more virtual representations in environment 304 based on the position (e.g., location and/or orientation) of the current viewpoint of user 306 (e.g., and electronic device 302) in environment 304. In some examples, electronic device 302 presents the one or more virtual representations in environment 304 in accordance with a determination that a location corresponding to the current viewpoint of user 306 in environment 304 is (e.g., has moved) outside of a threshold distance from real-world microwave 336 (e.g., after the timer starts). Accordingly, in overhead view 310 of FIG. 3B, a reference line 344 is shown. In some examples, movement of user 306 that exceeds reference line 344 in physical environment 308 corresponds to movement of the current viewpoint of user 306 relative to environment 304 that exceeds the threshold distance from real-world microwave 336 (e.g., in response to movement of user 306 that exceeds the threshold distance from real-world microwave 336 relative to environment 304, electronic device 302 presents the one or more virtual representations in environment 304). In some examples, the threshold distance is 0.1, 0.2, 0.5, 1, 2, 5 10, 20 or 30m from real-world microwave 336 relative to environment 304. In some examples, electronic device 302 presents the one or more virtual representations in accordance with a determination that user 306 has moved to a different room within an indoor space (e.g., reference line 344 corresponds to a region of physical environment 308 separating first room 324a from second room 324b). In some examples, electronic device 302 presents the one or more virtual representations in environment 304 in accordance with a determination that real-world user interface 316 is not within the field-of-view of user 306 or electronic device 302. For example, as shown in FIG. 3B, when real-world user interface 316 is within the field-of-view of user 306, electronic device 302 optionally forgoes presenting the content associated with real-world user interface 316 in environment 304. In some examples, electronic device 302 presents the one or more virtual representations in environment 304 in accordance with a determination that movement of the current viewpoint of user 306 exceeds an orientation threshold (e.g., 0.1, 0.5, 1, 2, 5, 10, 20, 30, 40, 45 50, 60, 70, 80, 90, 100, 120 or 180 degrees) relative to environment 304. For example, the viewpoint of user 306 has a first orientation relative to environment 304 when the one or more criteria (e.g., as described above) are met, and a second orientation, different from the first orientation, relative to environment 304 after the one or more criteria are met. In accordance with the difference between the first orientation and the second orientation exceeding the orientation threshold, electronic device 302 presents the one or more virtual representations in environment 304. Presenting one or more virtual representations in environment 304 based on a position (e.g., location and/or orientation) corresponding to the current viewpoint of user 306 relative to environment 304 ensures that the content is visible to user 306 when it is useful. For example, if the virtual representation includes a timer that corresponds to a time interval displayed by real-world user interface 316, and real-world user interface 316 is currently visible to user 306, then it is not necessary to present the virtual representation in environment 304 (e.g., because the time interval displayed by real-world user interface 316 is already visible to user 306).

FIG. 3C illustrates electronic device 302 presenting content associated with real-world user interface 316 in environment 304 in accordance with user 306 moving to second room 324b. Particularly, a virtual representation 312a is presented in environment 304. In some examples, electronic device 302 presents virtual representation 312a in environment 304 because the one or more criteria for presenting content associated with real-world user interface 316 in environment 304 (e.g., as described above) is satisfied. In some examples, electronic device 302 determines when to present virtual representation 312a in environment 304 based on the position (e.g., location and/or orientation) of the current viewpoint of user 306 (e.g., electronic device 302 presents virtual representation 312a when user 306 moves to room 326b). As shown in FIG. 3C, virtual representation 312a includes a timer corresponding to the time interval displayed by real-world user interface 316 in FIG. 3B (e.g., the view of environment 304 shown in FIG. 3C is 12 seconds later than the view of environment 304 shown in FIG. 3B). For example, electronic device 302 updates the timer included in virtual representation 312a to correspond to the current value of the timer presented by real-world user interface 316 independent of whether real-world user interface 316 is current visible to user 306 or electronic device 302. For example, when real-world user interface 316 is visible to user 306 or electronic device 302 and virtual representation 312a is not presented in environment 304, electronic device 302 tracks the amount of time remaining on the timer displayed by real-world user interface 316. For example, when real-world user interface 316 is not visible to user 306 or electronic device 302 and virtual representation 312 is presented in environment 304, electronic device 302 presents the timer included in virtual representation 312 with the correct amount of time remaining (e.g., the presented amount of time remaining corresponds to the amount of time remaining on the timer displayed by real-world user interface 316 because electronic device 302 continues to update the timer independent of whether real-world user interface 316 is visible).

In some examples, virtual representation 312a includes one or more selectable options. As shown in FIG. 3C, virtual representation 312a includes a first selectable option 334a and a second selectable option 334b. In some examples, first selectable option 334a is selectable to cease presentation of virtual representation 312a in environment 304, and second selectable option 334b is selectable to pause or continue the countdown of the timer presented by virtual representation 312a. In some examples, first selectable option 334a and second selectable option 334b are selectable through a selection input corresponding to attention (e.g., gaze) directed to first selectable option 334a or second selectable option 334b while an air gesture (e.g., air pinch, air long pinch, air tap, air drag or air pinch) is optionally performed by user 306. In some examples, electronic device 302 presents virtual representation 312a with a subset of the above described selectable options or without the one or more selectable options (e.g., virtual representation 312a is presented without first selectable option 334a and/or second selectable option 334b). In some examples, virtual representation 312a is presented at a head-locked and/or body-locked orientation relative to the current viewpoint of user 306 (e.g., virtual representation 312a is not displayed at a world-locked orientation (e.g., at a location corresponding to real-world user interface 316 and/or real-world microwave 336)).

In FIG. 3C, virtual representation 312a is presented at a bottom-right corner of environment 304 from the current viewpoint of user 306. In some examples, virtual representation 312a is alternatively presented in an area of environment 304 different from the bottom-right corner of environment 304 (e.g., upper-right corner, a left corner, bottom, top and/or side of the display area of environment 304 from the current viewpoint of user 306). In some examples, virtual representation 312a is presented at a location relative to the current viewpoint of user 306 that avoids visual (e.g., spatial) conflicts with one or more objects visible in environment 304 (e.g., as shown in FIG. 3C, virtual representation 312a does not overlap and/or intersect with real-world TV 340 and real-world table 342 from the current viewpoint of user 306). In some examples, virtual representation 312a is presented at a location that overlaps in front of one or more objects in environment 304 from the current viewpoint of user 306 (e.g., electronic device 302 presents virtual representation 312a at a closer distance relative to the current viewpoint of user 306 in environment 304 than the one or more objects visible in environment 304). In some examples, virtual representation 312a is presented at a default display location relative to the current viewpoint of user 306 (e.g., the display location is established by one or more default settings of electronic device 302). In some examples, virtual representation 312a is presented at a display location that is set by user 306 (e.g., user 306 establishes a display location of virtual representation 312a through one or more settings accessed through a system and/or settings user interface of electronic device 302, and/or the display location is included in a user profile associated with user 306).

In some examples, electronic device 302 maintains presentation of virtual representation 312a in environment 304 until user 306 provides an input corresponding to a request to cease presentation of virtual representation 312a (e.g., through selection of first selectable option 334a). In some examples, electronic device 302 maintains presentation of virtual representation 312a in environment 304 until the countdown of the timer is completed (e.g., electronic device 302 automatically ceases presentation of virtual representation 312a after notifying user 306 that the timer is completed). In some examples, electronic device 302 presents virtual representation 312a in environment 304 with one or more dynamic visual characteristics. For example, electronic device 302 presents virtual representation 312a with different magnitudes of brightness (e.g., virtual representation 312a is flashed/flickered in environment 304) and/or color (e.g., a color of virtual representation 312a is changed based on the amount of time remaining). In some examples, electronic device 302 presents virtual representation 312a periodically (e.g., as shown and described with reference to FIG. 3F). In some examples, virtual representation 312a is presented without text (e.g., without the word “Timer” as shown in FIG. 3C) and/or a virtual container (e.g., without the border presented around virtual representation 312a shown in FIG. 3C).

FIGS. 3D-3E illustrate an example of presenting content associated with real-world user interface 316 in environment 304 that is different from virtual representation 312a. Particularly, in some examples, electronic device 302 adds content associated with real-world user interface 316 (e.g., a timer) to a system user interface (e.g., system user interface 320 shown and described with reference to FIG. 3E). In some examples, electronic device 302 adds the content associated with real-world user interface 316 to the system user interface in addition to presenting virtual representation 312a in environment 304. In some examples, the system user interface is accessible to user 306 in environment 304 through one or more user inputs. For example, in FIG. 3D, user 306 provides an input that includes attention (e.g., gaze 318) directed to a region (e.g., an upper region) of environment 304. In some examples, the region of environment 304 that gaze 318 is directed to is different from the region of environment 304 shown in FIG. 3D at which the virtual representation 312a was displayed (e.g., a lower region, a corner, a side region and/or empty space (e.g., a region of environment 304 that does not include virtual and/or real-world objects) of environment 304). In some examples, the region of environment 304 that gaze 318 is directed to is a default region of environment 304 (e.g., corresponding to a default setting of electronic device 302) associated with presenting the system user interface. In some examples, the region of environment 304 that gaze 318 is directed to is set by user 306 (e.g., through one or more settings associated with a user profile). In some examples, the input provided by user 306 includes gaze 318 directed to the region of environment 304 for a threshold amount of time (e.g., 0.1, 0.2, 0.5, 1, 2, 5 or 10 seconds). For example, in accordance with gaze 318 being directed to the region of environment 304 for less than the threshold amount of time, electronic device 302 forgoes presenting the system user interface in environment 304. In some examples, the input provided by user 306 includes an air gesture (e.g., in addition to gaze 318 directed to the region of environment 304). For example, the air gesture includes an air pinch, long air pinch (e.g., an air pinch held for 0.1, 0.2, 0.5, 1, 2, 5 or 10 seconds) air tap and/or air point performed by a hand of user 306.

FIG. 3E illustrates system user interface 320 presented in environment 304 in response to the input provided by user 306 in FIG. 3D. In some examples, system user interface 320 includes one or more virtual elements, including notifications, icons and/or widgets associated with one or more applications. As shown in FIG. 3E, system user interface 320 includes a virtual representation 346a and a virtual representation 346b. In some examples, virtual representation 346a corresponds to a notification received from a messaging application (e.g., the notification is associated with a text message received by electronic device 302 (e.g., and/or optionally from a device in communication with electronic device 302)). In some examples, virtual representation 346b corresponds to a notification received from a calendar application (e.g., the notification is associated with an event). In some examples, system user interface 320 includes one or more visual indications not included in FIG. 3E (e.g., system user interface 320 includes an indication of a current time, date, and/or weather (e.g., an outdoor temperature of a location associated with the current location of electronic device 302)). In some examples, system user interface 320 includes one or more menus for reviewing and/or updating settings (e.g., system, device and/or user settings). In some examples, as shown in FIG. 3E, electronic device 302 changes a visual appearance of environment 304 when presenting system user interface 320. For example, electronic device 302 reduces the opacity, color, saturation, brightness and/or sharpness of one or more objects (e.g., including virtual objects and/or representations of real-world objects) in environment 304 when presenting system user interface 320. In some examples, electronic device 302 does not change the visual appearance of environment 304 when presenting system user interface 320.

As shown in FIG. 3E, system user interface 320 includes virtual representation 312b. In some examples, virtual representation 312b includes a timer corresponding to the time interval displayed by real-world user interface 316 in FIG. 3B (e.g., the view of environment 304 shown in FIG. 3E is 30 seconds later than the view of environment 304 shown in FIG. 3B). In some examples, electronic device 302 adds virtual representation 312b to system user interface 320 in response to the interaction of user 306 with real-world user interface 316 shown in FIGS. 3A-3B (e.g., electronic device 302 detects the user input shown in FIG. 3A and/or the change in appearance of real-world user interface 316 in FIG. 3B, and in response, electronic device 302 adds virtual representation 312b to system user interface 320). In some examples, electronic device 302 presents virtual representation 312a in environment 304 (e.g., in accordance with a determination that a location corresponding to the current viewpoint of user 306 is more than a threshold distance from real-world microwave 336 (e.g., as shown and described with reference to FIGS. 3B-3C)) and adds virtual representation 312b to system user interface 320. In some examples, if electronic device 302 presents virtual representation 312a in environment 304, electronic device 302 ceases to present virtual representation 312a in environment 304 when system user interface 320 including the virtual representation 312b is presented with virtual representation 312b. In some examples, virtual representation 312b includes one or more selectable options for controlling the timer included in virtual representation 312b (e.g., selectable options for dismissing, stopping and/or resuming the timer).

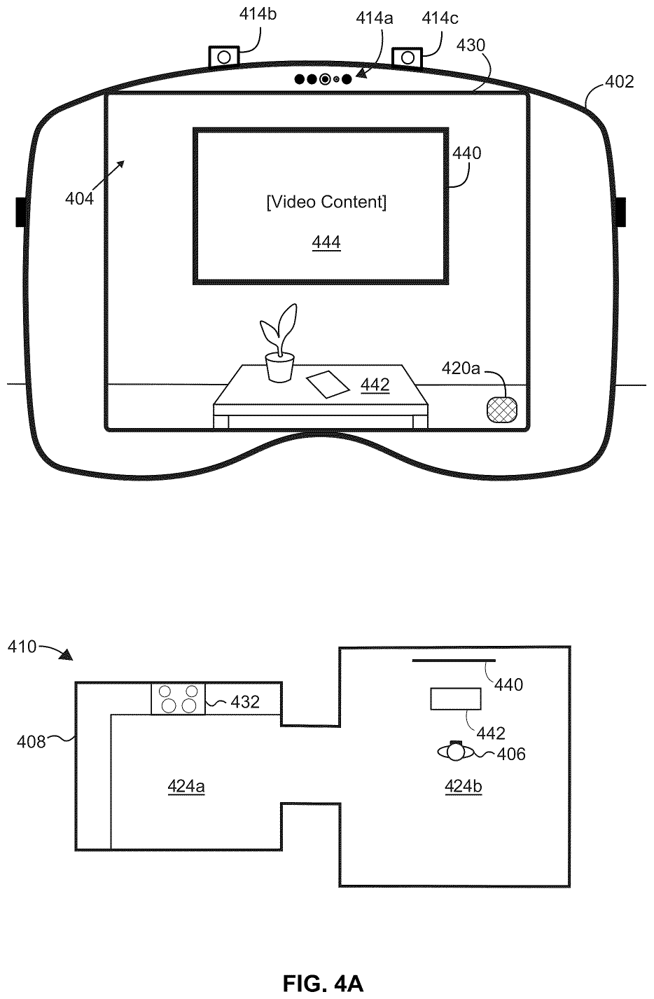

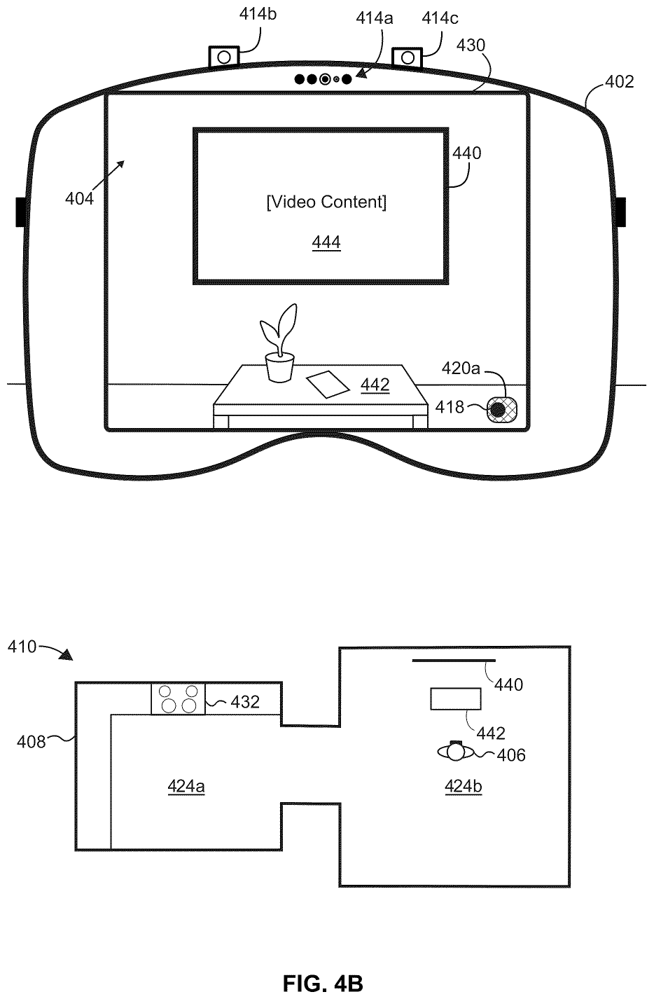

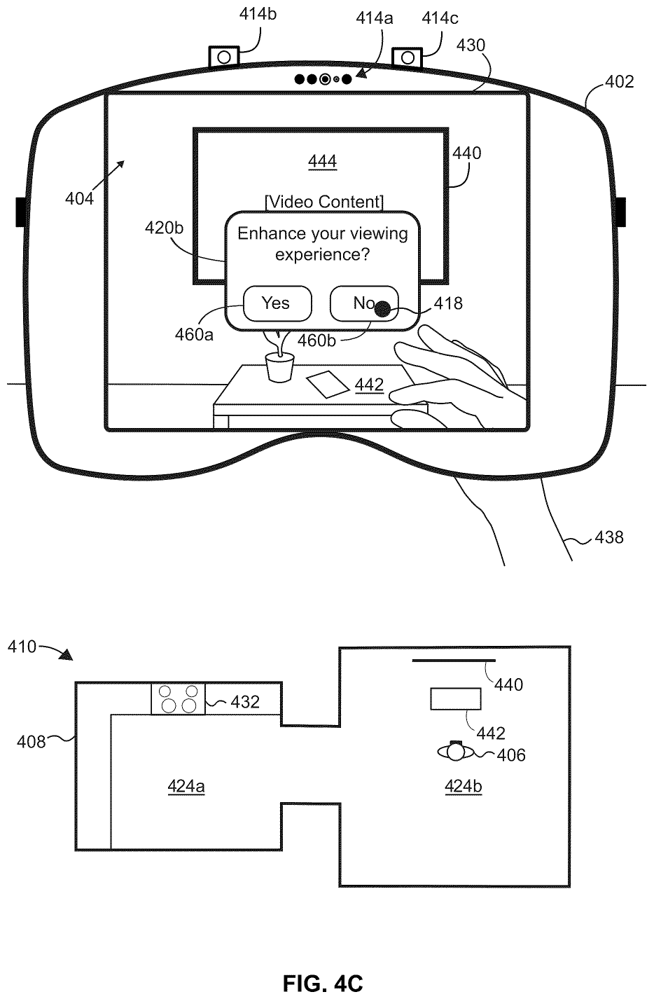

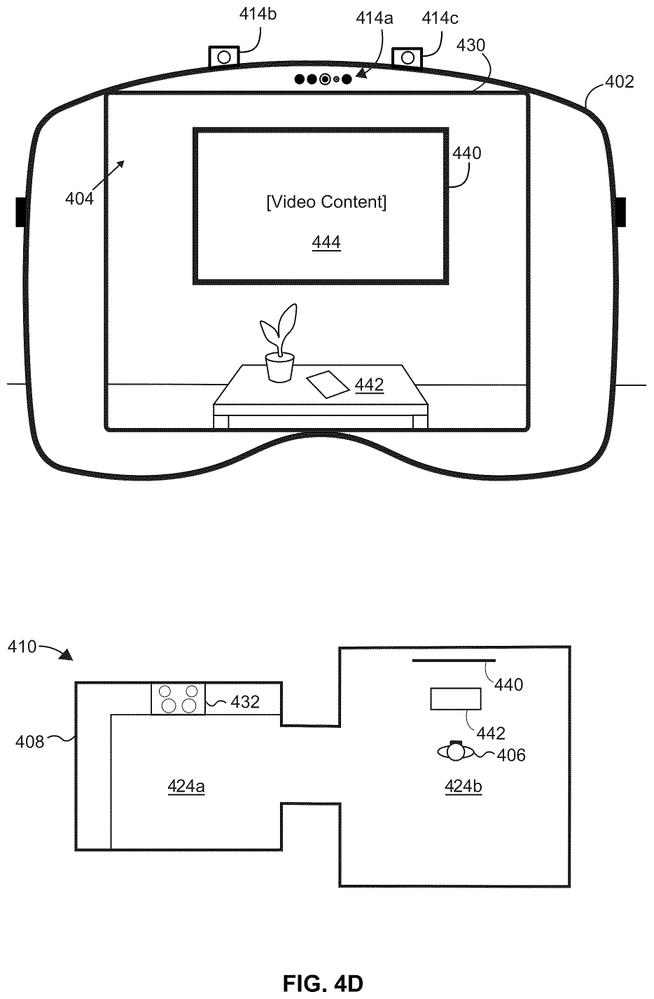

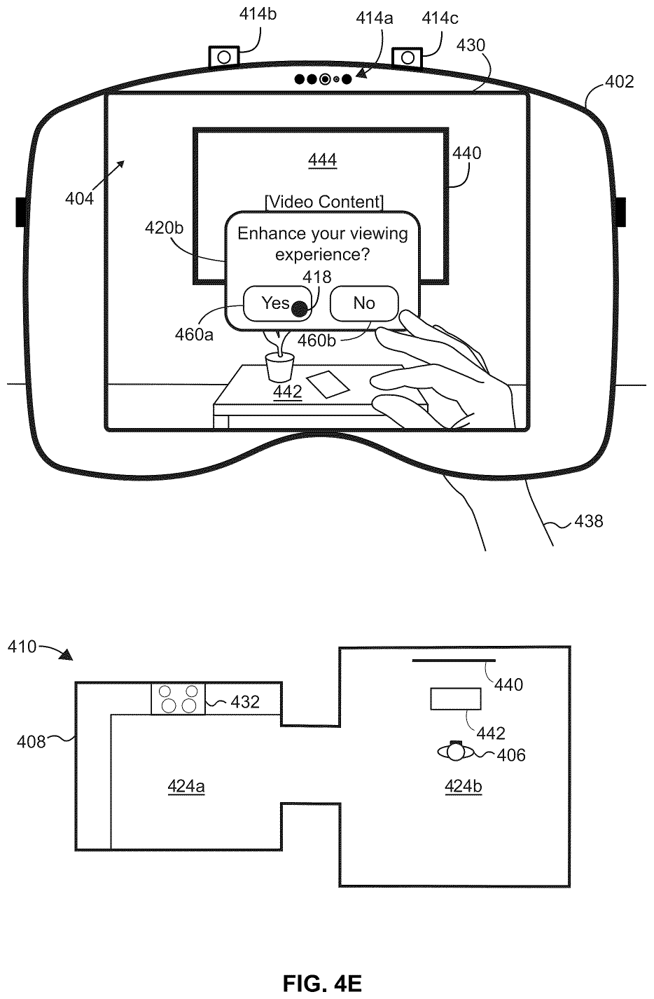

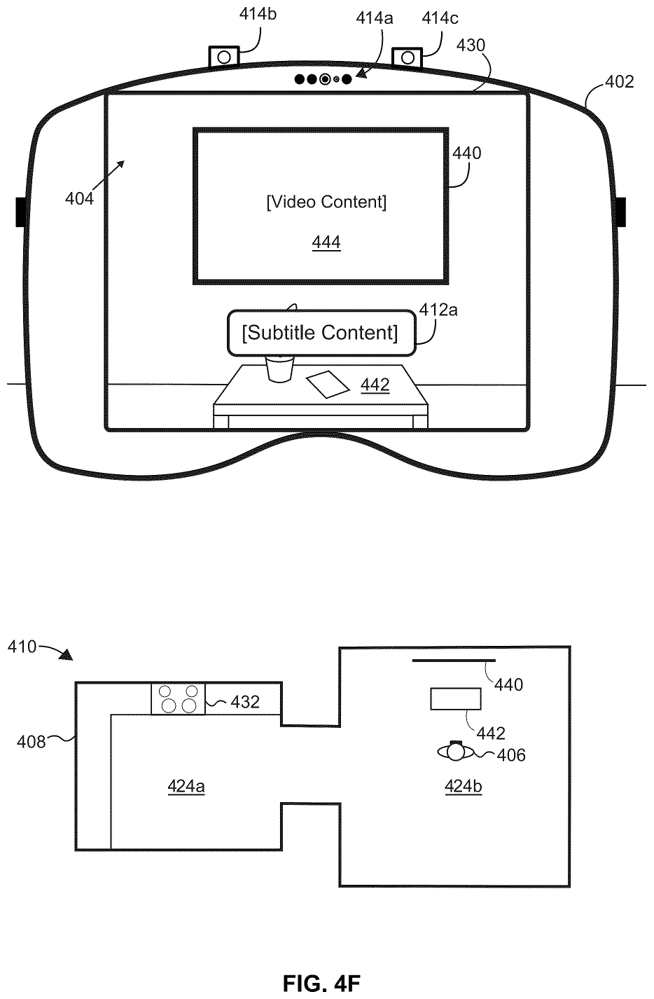

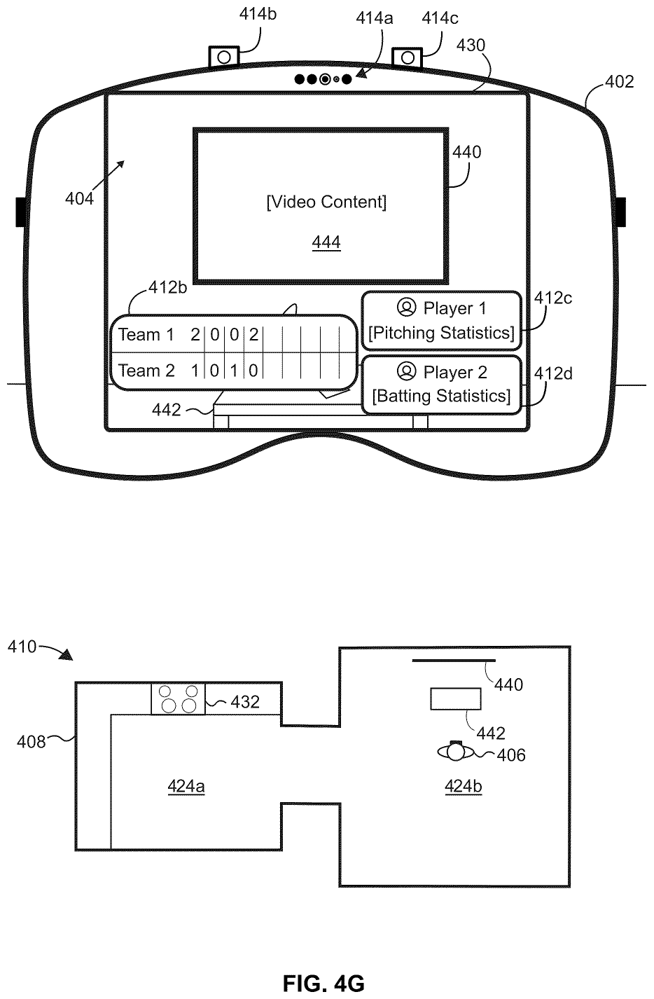

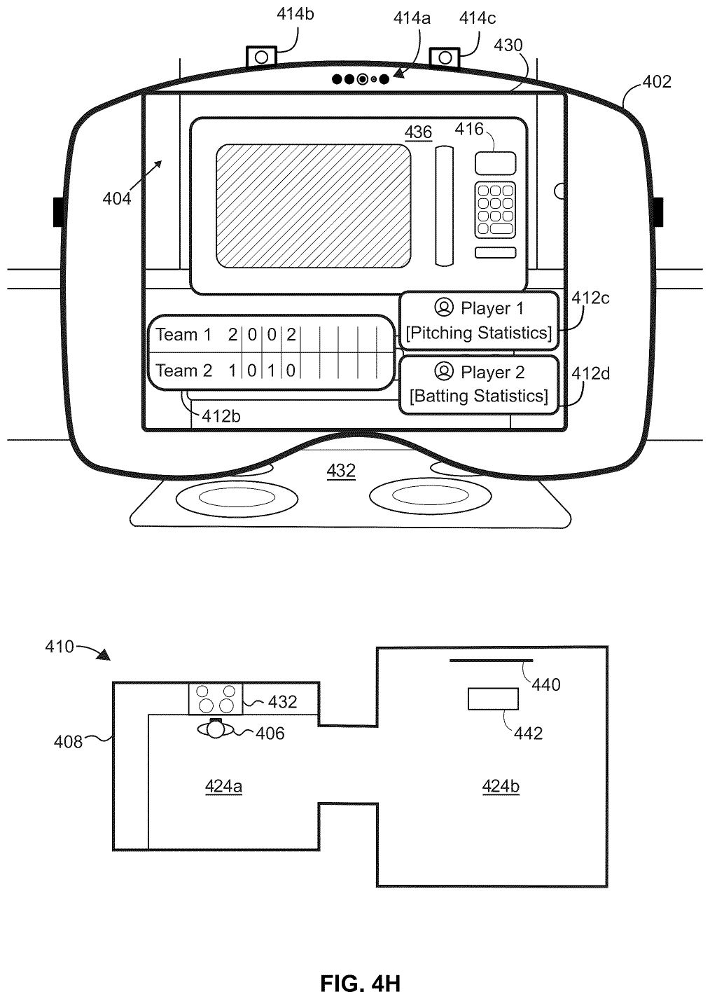

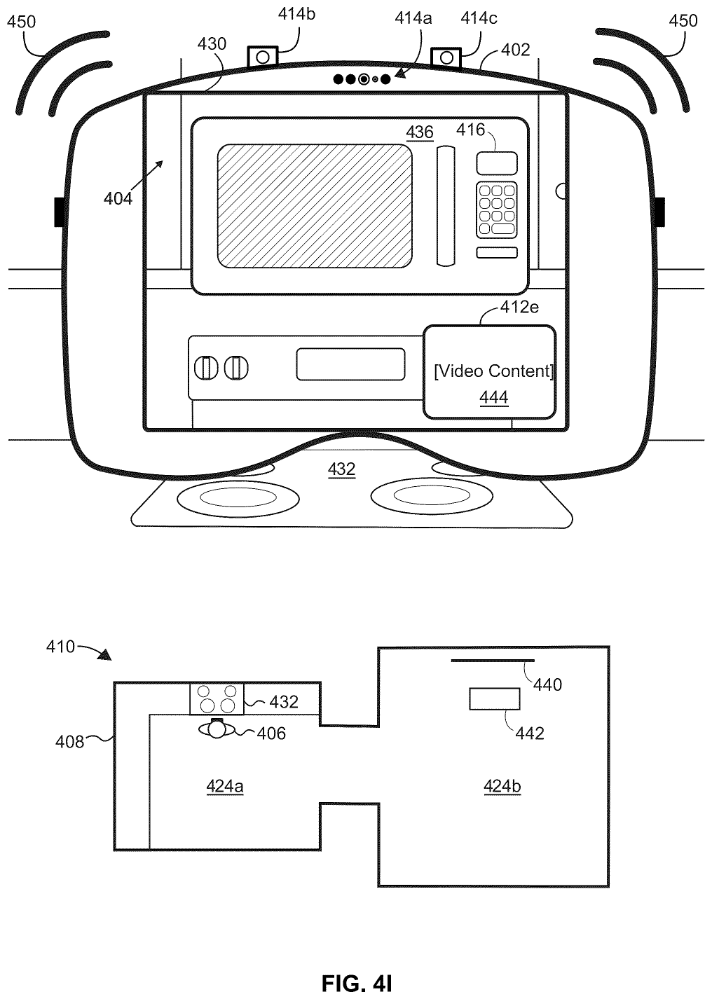

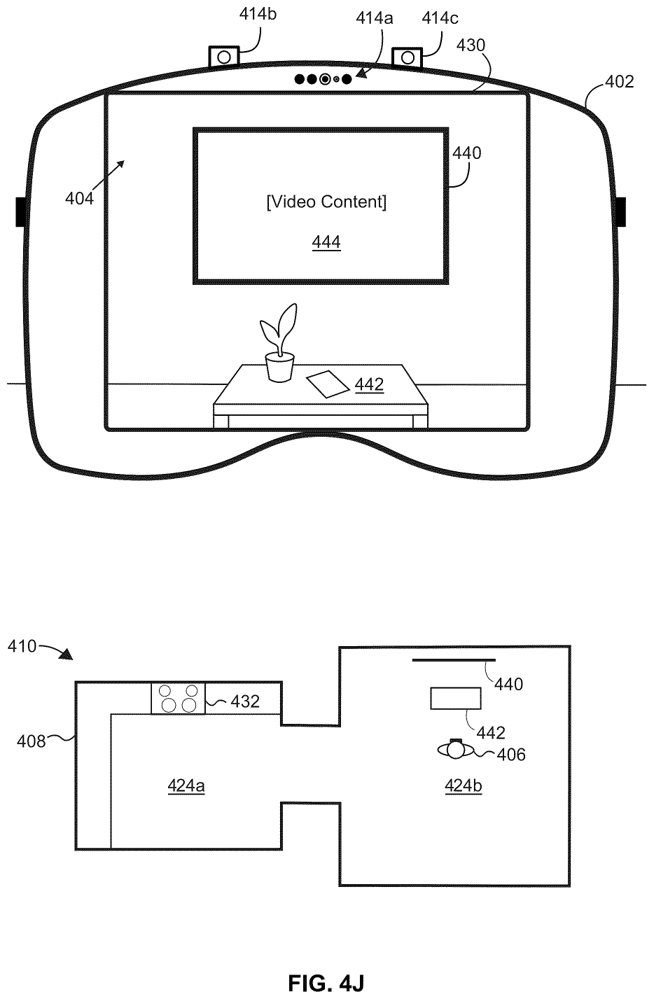

In some examples, electronic device 302 adds a plurality of virtual representations (e.g., corresponding to content associated with one or more real-world objects and/or user interfaces) to system user interface 320. For example, electronic device 302 detects user interaction with one or more real-world user interfaces different from real-world user interface 316 (e.g., a real-world user interface associated with a real-world washing machine, dryer, TV, mobile device, laptop, and/or wearable device (e.g., a smart watch)), and in accordance with one or more criteria being satisfied (e.g., as described above), electronic device 302 adds one or more virtual representations (e.g., corresponding to virtual representation 312b and/or virtual representations 412a-412e shown and described with reference to FIGS. 4F-4I) including content associated with the one or more real-world user interfaces to system user interface 320. In some examples, the one or more virtual representations include a timer that is not associated with a real-world user interface (e.g., the timer is set by a user input different from interaction with a real-world user interface (e.g., a verbal input and/or a user input provided through an application)).

FIG. 3F illustrates an example of presenting content associated with real-world user interface 316 in environment 304 different from virtual representation 312a and virtual representation 312b. In FIG. 3F, a virtual representation 312c is presented in environment 304. In some examples, electronic device 302 periodically presents virtual representation 312c in addition to adding virtual representation 312b to system user interface 320 (e.g., as shown and described with reference to FIG. 3E). For example, during a first time period, electronic device 302 detects real-world user interface 316 and/or user interaction with real-world user interface 316 and stores information associated with the real-world user interface 316 (e.g., storing the time interval displayed by the real-world user interface 316). For example, at a second time period after the first time period (e.g., when less than a threshold amount of time is remaining on the timer that was displayed by real-world user interface 316), electronic device 302 presents virtual representation 312c in environment 304. In some examples, electronic device 302 presents one or more notifications in environment 304 corresponding to an amount of time remaining on the timer associated with real-world user interface 316. As shown in FIG. 3F, virtual representation 312c includes an indication that 10 seconds are remaining in the timer (e.g., the view of environment 304 shown in FIG. 3F is presented 110 seconds later than the view of environment 304 shown in FIG. 3B). In some examples, virtual representation 312c is presented when a different amount of time is remaining in the timer (e.g., 0, 5, 15, 20, 25, 30, or 60 seconds, and/or 2, 5, 10, 15, 20, 25, 30, 60 or 120 minutes). In some examples, the periodicity of the presentation of virtual representation 312c is set by one or more default settings of electronic device 302. In some examples, the periodicity of the presentation of virtual representation 312c is set by user 306 (e.g., through one or more settings associated with a user profile, or one or more settings associated with an application). In some examples, presenting virtual representation 312c in environment 304 includes providing audio output (e.g., through an output device of electronic device 302 (e.g., a speaker)). In some examples, electronic device 302 ceases to present virtual representation 312c in environment 304 after a threshold amount of time (e.g., 1, 2, 5, 10, 15, 20, 25, 30, 60 or 120 seconds). In some examples, electronic device 302 ceases to present virtual representation 312c in environment 304 in response to a user input corresponding to a request to cease presentation of virtual representation 312c (e.g., the user input includes a selection of a selectable option for ceasing to present virtual representation 312c, a verbal input (e.g., a voice command), and/or an air gesture).

In some examples, in accordance with electronic device 302 detecting user interaction with one or more real-world user interfaces different from real-world user interface 316 (e.g., as described above) and tracking multiple timers (e.g., the multiple timers are added to system user interface 320), electronic device 302 presents a virtual representation 312c that corresponds to a prioritized timer of the multiple timers. For example, the prioritized timer corresponds to a most recent timer (e.g., user 306 has most recently interacted with a real-world user interface that is associated with the prioritized timer). For example, the prioritized timer corresponds to a timer that has an amount of remaining time that is less than a threshold amount of time (e.g., less than 1, 5, 10, 15, 20, 25, 30, or 60 seconds, and/or less than 2, 5, 10, 15, 20, 25, 30, 60 or 120 minutes). For example, the prioritized timer corresponds to a timer that electronic device 302 determines is prioritized based on detection of user input (e.g., user 306 provides verbal input corresponding to a request to prioritize the timer and/or the timer is set to be prioritized by user 306 through one or more settings of a user profile).

FIGS. 4A-4J illustrate an electronic device presenting content in an environment that corresponds to a user interface of a real-world object (e.g., an object included in a physical environment), according to some examples of the disclosure. In some examples, the content includes one or more virtual representations associated with video content displayed by a physical display of a real-world TV. In some examples, the one or more virtual representations include information and/or supplemental content associated with the video content displayed by the real-world TV in the physical environment (e.g., the information and/or supplemental content include subtitles, metadata, annotations, and/or information associated with the video content (e.g., optionally, the information and/or supplemental content is not included in the video content that is displayed by the real-world TV)). In some examples, electronic device 402 has one or more characteristics of electronic device 302 shown and described with reference to FIGS. 3A-3E. As shown in FIGS. 4A-4J, electronic device 402 includes a display generation component 430 (e.g., display generation component 430 has one or more characteristics of display generation component 330 described with reference to FIGS. 3A-3F). In some examples, image sensors 414a-414c have one or more characteristics of image sensors 314a-314c. In some examples, environment 404 has one or more characteristics of environment 304 shown and described with reference to FIGS. 3A-3F. In some examples, physical environment 408 (e.g., shown in overhead view 410) has one or more characteristics of physical environment 308 shown and described with reference to FIGS. 3A-3F.

FIG. 4A illustrates user 406 viewing video content 444 that is displayed by a real-world user interface (e.g., a physical display) of real-world TV 440 in physical environment 408. In some examples, electronic device 402 detects the real-world user interface of real-world TV 440 (e.g., using image sensors 414a-414c). In some examples, user 406 views video content 444 displayed by real-world TV 440 through display generation component 430 (e.g., the physical display of real-world TV 440 is visible through video pass-through or optical see-through). In some examples, video content 444 includes a movie, TV show, a live television program (e.g., a sporting event shown on cable television or streamed through a streaming service), and/or an online video from a video sharing service or social media application. In some examples, video content 444 includes content that is casted to real-world TV 440 from an electronic device (e.g., electronic device 402 or a different electronic device (e.g., such as a mobile device, laptop, and/or a wearable device (e.g., a smart watch or a head-mounted display)). As shown in overhead view 410, real-world TV 440 is included in room 424b of physical environment 408. In some examples, physical environment 408 includes one or more objects different from real-world TV 440 that are visible to user 406 through video passthrough and/or optical see through (e.g., real-world table 442).

In some examples, electronic device 402 detects video content 444 displayed by real-world TV 440 (e.g., using image sensors 414a-414c and/or one or more audio sensors (e.g., having one or more characteristics microphone(s) 213 described with reference to FIG. 2). In some examples, electronic device 402 detects attention (e.g., gaze) of user 406 directed to a location in environment 404 corresponding to real-world TV 440 (e.g., in addition to detecting video content 444 displayed by real-world TV 440). In some examples, electronic device 402 identifies video content 444 displayed by real-world TV 440 through a database (e.g., the database includes information for identifying video content 444 (e.g., images, videos and/or audio prints associated with video content 444)). For example, the database is stored by electronic device 402 in a memory, or is stored by a device (e.g., owned and/or operated by a third party) that electronic device 402 is in communication with (e.g., via a network). In some examples, electronic device 402 receives information corresponding to video content 444 from an application that video content 444 is associated with (e.g., the application is accessible on real-world TV 440 and/or electronic device 402). For example, electronic device 402 uses the information corresponding to video content 444 to present the content associated with video content 444 (e.g., virtual representations 412a-412e shown and described with reference to FIGS. 4F-4I) in environment 404.

In some examples, in response to detecting the real-world user interface of real-world TV 440, video content 444 and/or attention of user 406 directed to video content 444 (e.g., for a threshold period of time (e.g., 0.1, 0.2, 0.5, 1, 2, 5 or 10 seconds)), electronic device 402 presents a virtual element 420a in environment 404, as shown in FIG. 4A. In some examples, virtual element 420a is interactable to present content (e.g., virtual content) in environment 404 that is associated with video content 444. For example, virtual element 420a is interactable through user input corresponding to attention directed to virtual element 420a (e.g., user 406 directs gaze to virtual element 420a (e.g., for a threshold period of time, such as 0.1, 0.2, 0.5, 1, 2, 5 or 10 seconds)). As shown in FIG. 4A, virtual element 420a is presented at a lower right corner of environment 404 from the current viewpoint of user 406. In some examples, virtual element 420a is alternatively presented in a different region of environment 404 from the current viewpoint of user 406 (e.g., a lower left corner, an upper corner, an upper region, a lower region, a left region, a right region and/or an empty space of environment 404). In some examples, virtual element 420a is presented with one or more visual characteristics different from those shown in FIG. 4A (e.g., different magnitudes of brightness, color, saturation, sharpness, size, opacity). In some examples, virtual element 420a is presented with one or more dynamic visual characteristics (e.g., varying brightness and/or color (e.g., flashing)). In some examples, virtual element 420a is presented periodically in environment 404 (e.g., every 1, 2, 5, 10, 30, 60, 90 or 120 seconds) for a threshold period of time (e.g., 1, 2, 5, 10, 30, 60, 90 or 120 seconds). In some examples, presenting virtual element 420a in environment 404 includes providing an audio output (e.g., through one or more output devices of electronic device 402). In some examples, electronic device 402 ceases to present virtual element 420a in environment 404 when the electronic device 402 detects that user 406 has not interacted with virtual element 420a within a threshold period of time (e.g., 5, 10, 20, 30, 60, 100 or 120 seconds). In some examples, electronic device 402 ceases to present virtual element 420a in environment 404 in response to an input provided by user 406 corresponding to a request to cease presentation of virtual element 420a in environment 404 (e.g., the input includes an air gesture, interaction with a selectable option included in virtual element 420a, a verbal input, and/or actuation of a hardware button of electronic device 402).

FIG. 4B illustrates attention of user 406 being directed to virtual element 420a. As shown in FIG. 4B, gaze 418 of user 406 is directed to virtual element 420a. In some examples, gaze 418 is directed to virtual element 420a for a threshold amount of time (e.g., 0.1, 0.2, 0.5, 1, 2, 5 or 10 seconds). In some examples, detecting attention of user 406 being directed to virtual element 420a includes detecting an air gesture (e.g., an air pinch, long air pinch (e.g., an air pinch held for 0.1, 0.2, 0.5, 1, 2, 5 or 10 seconds) air tap and/or air point) performed by a hand of user 406 (e.g., optionally while detecting gaze 418 directed to virtual element 420a). In some examples, in response to detecting attention (e.g., gaze 418) directed to virtual element 420a (e.g., for more than the threshold amount of time), electronic device 402 presents content in environment 404 that is associated with the video content displayed by real-world TV 440 (e.g., such as shown and described with reference to FIGS. 4F-4G). In some examples, in response to detecting attention being directed to virtual element 420a, electronic device 402 presents a second virtual element in environment 404 (e.g., as shown and described with reference to FIG. 4C).

FIG. 4C illustrates electronic device 402 presenting a virtual element 420b in environment 404 in response to the input provided by user 406 in FIG. 4B. In some examples, virtual element 420b is presented by electronic device 402 to confirm that the intent of user 406 is to present content in environment 404 associated with video content 444 displayed by real-world TV 440. In some examples, virtual element 420b includes one or more selectable options 460a and 460b. In some examples, selectable option 460a is selectable to present content associated with video content 444 in environment 404. In some examples, selectable option 460b is selectable to cease presentation of virtual element 420b in environment 404 (e.g., selectable option 460b is selectable to forgo presentation of content associated with video content 444 in environment 404). In some examples, selectable options 460a and 460b are selectable through a user input that includes attention directed to selectable options 460a or 460b. As shown in FIG. 4C, electronic device 402 detects a user input that incudes gaze 418 directed to selectable option 460b (e.g., for a threshold period of time (e.g., 0.1, 0.2, 0.5, 1, 2, 5 or 10 seconds)). In some examples, the user input includes an air gesture (e.g., while attention is directed to selectable option 460a or 460b). As shown in FIG. 4C, the air gesture (e.g., an air pinch) is optionally performed by the user with hand 438. In some examples, electronic device 402 ceases to present virtual element 420b in environment 404 in response to a user input different from selection of selectable option 460b (e.g., user 406 provides a verbal input, an air gesture and/or actuates a hardware button of electronic device 402). It should be appreciated that, in some examples, electronic device 402 does not present virtual element 420b in response to the input provided by user 406 in FIG. 4B. For example, in response to the interaction with virtual element 420a in FIG. 4B, electronic device 402 presents the content associated with video content 444 in environment 404 (e.g., as shown and described with reference to FIGS. 4F-FI). It should be appreciated that, in some examples, electronic device 402 presents virtual element 420b in environment 404 in response to one or more criteria being met that are different from other criteria that are satisfied when the input provided by user 406 in FIG. 4B is detected. For example, electronic device 402 does not present virtual element 420a in environment 404 and, in response to electronic device 402 detecting the real-world user interface of real-world TV 440, video content 444 and/or attention of user 406 directed to real-world TV 440, electronic device 402 presents virtual element 420b in environment 404.

FIG. 4D illustrates electronic device 402 forgoing presenting content in environment 404 corresponding to video content 416 in response to the input provided by user 406 in FIG. 4C. Particularly, electronic device 402 forgoes presenting content in environment 404 in response to selection of selectable option 460b in FIG. 4C. Additionally, as shown in FIG. 4D, in response to the input provided by user 406 in FIG. 4C, electronic device 402 ceases to present virtual element 420b in environment 404. In some examples, as shown in FIG. 4D, electronic device 402 forgoes presenting virtual element 420a in environment 404 when ceasing to present virtual element 420b in environment 404 (e.g., because electronic device 402 identifies that the intent of user 406 is not to present content in environment 404 associated with video content 444 based on the input provided by user 406 in FIG. 4C).

FIG. 4E illustrates an alternative example to FIG. 4C where user 406 provides an input corresponding to selection of selectable option 460a (e.g., instead of selectable option 460b). As shown in FIG. 4E, electronic device 402 detects gaze 418 directed to selectable option 460a (e.g., for a threshold period of time (e.g., 0.1, 0.2, 0.5, 1, 2, 5 or 10 seconds). Further, as shown in FIG. 4E, electronic device 402 detects user 406 perform an air gesture (e.g., an air pinch) with hand 438 (e.g., while attention of user 406 is directed to selectable option 460a). In some examples, the input provided by user 406 in FIG. 4E corresponds to a request to present content in environment 404 associated with video content 444. In some examples, electronic device 402 presents content in environment 404 associated with video content 444 in response to a user input different from the air gesture selecting selectable option 460a (e.g., user 406 provides a verbal input, provides an air gesture and/or actuates a hardware button of electronic device 402).

In some examples, electronic device 402 presents one or more types of content associated with video content 444 in environment 404. For example, the content presented by electronic device 402 that is associated with video content 444 includes subtitles, audio output, picture-in-picture, metadata and/or visual graphics including supplemental information associated with video content 444. In some examples, the type of content presented by electronic device 402 in environment 404 is determined based on user input. For example, electronic device 402 presents a type of content that is based on one or more settings that are stored in a user profile (e.g., the one or more settings are set by user 406 and correspond to preferred types of content). For example, electronic device 402 presents a type of content that corresponds to an audio input (e.g., a verbal command provided by user 406). For example, electronic device 402 presents a type of content that is based on a location of user 406 relative to physical environment 408 (e.g., if real-world TV 440 is in the field-of-view of user 406, then electronic device 402 presents visual graphics including supplemental information and forgoes presenting a picture-in-picture presentation of video content 444).

FIG. 4F illustrates a virtual representation 412a presented in environment 404 in response to the input provided by user 406 in FIG. 4E. As shown in FIG. 4F, virtual representation 412a includes subtitle content that is presented in environment 404. In some examples, the subtitle content corresponds to subtitles for video content 444 (e.g., the subtitles are presented in environment 404 in synchronization with video content 444 displayed by real-world TV 440). For example, after electronic device 402 identifies video content 444 that is displayed by real-world TV 440, electronic device 402 retrieves subtitle information for the video content 444 (e.g., from a database stored in a memory, another electronic device that electronic device 402 is in communication with, and/or an application (e.g., a streaming service application) that video content 444 is associated with).

In FIG. 4F, virtual representation 412a is presented in a region of environment 404 that is below real-world TV 440 from the current viewpoint of user 406. In some examples, subtitles are presented at a default location in environment 404 and/or at a location in environment 404 that is preferred by user 406 (e.g., user 406 sets a preferred location of virtual element 420a in one or more settings of electronic device 402 and/or one or more settings of a user profile). In some examples, virtual representation 412a is presented in an empty space of environment 404 (e.g., a region of environment 404 that does not include virtual and/or real-world objects). In some examples, virtual representation 412a is presented concurrently with different types of content associated with video content 444 (e.g., with virtual representations 412b-412d as shown and described with reference to FIGS. 4G-4H). In some examples, electronic device 402 presents virtual representation 412a when video content 444 is included in the field-of-view of user 406 (e.g., in accordance with video content 444 not being within the field-of-view of user 406, electronic device 402 forgoes presenting virtual representation 412a in environment 404). In some examples, electronic device 402 forgoes presenting virtual representation 412a when subtitles are included in video content 444 (e.g., subtitles corresponding to video content 444 are displayed by real-world TV 440 in physical environment 408). In some examples, electronic device 402 presents virtual representation 412a based on a level of audio (e.g., in decibels) detected from real-world TV 440. For example, in accordance with the detected level of audio being less than a threshold amount, electronic device 402 presents virtual representation 412a in environment 404.

FIG. 4G illustrates virtual representations 412b-412d presented in environment 404 in response to the input provided by user 406 in FIG. 4E. As shown in FIG. 4G, virtual representations 412b and 412c include metadata and/or supplemental information associated with video content 444. For example, video content 444 is a broadcasted sporting event (e.g., a baseball game), and virtual representations 412b and 412c include metadata and/or information that is associated with the sporting event (e.g., virtual representation 412b includes a box score of a baseball game, and virtual representations 412b-412c include statistics for one or more players of the baseball game). In some examples, video content 444 is a movie or a TV show, and virtual representations 412b-412d include information associated with the movie or TV show (e.g., cast, episode name/number, runtime and/or description). In some examples, video content 444 is live television, and virtual representations 412b-412d include a broadcast schedule and/or channel guide. In some examples, video content 444 is an online video from a video sharing service or social media application, and virtual representations 412b-412d include a video name, description, playback controls, playback progress bar, user profile information (e.g., associated with the creator of the video) and/or user comments (e.g., from one or more viewers of the video).

In some examples, content corresponding to metadata and/or supplemental information associated with video content 444 is presented through one or more virtual representations. For example, presenting the content includes presenting the metadata and/or information in a virtual object and/or virtual container (e.g., the metadata and/or information is included in one virtual object that is presented in environment 404). In FIG. 4G, virtual representations 412b-412d are presented in a lower region of environment 404 from the current viewpoint of user 406. In some examples, virtual representations 412b-412d are alternatively presented in a different region of environment 404 from the current viewpoint of user 406 (e.g., a lower left corner, an upper corner, an upper region, a lower region, a left region, a right region and/or an empty space of environment 404). In some examples, the content corresponding to metadata and/or supplemental information associated with video content 444 is presented in a default location (e.g., as defined by one or more system and/or device settings) or a user preferred location (e.g., as defined by one or more settings included in a user profile) in environment 404 from the current viewpoint of user 406. In some examples, virtual representations 412b-412d are movable in environment 404 from the current viewpoint of user 406 through user input (e.g., the user input includes attention directed to one or more of virtual representations 412b-412d and/or an air gesture). In some examples, electronic device 402 ceases to present virtual representations 412b-412d in response to user input (e.g., corresponding to a request to cease presentation of virtual representations 412b-412d). For example, virtual representations 412b-412d include one or more selectable options for ceasing to present virtual representations 412b-412d, and the user input corresponds to selection of the one or more selectable options. For example, the user input includes a verbal input (e.g., a voice command) and/or an air gesture.

FIG. 4H illustrates virtual representations 412b-412d presented in environment 404 when real-world TV 440 is not visible in environment 404 from the current viewpoint of user 406. As shown in overhead view 410, user 406 has moved in physical environment 408 from room 424b to room 424a (e.g., the movement of user 406 in physical environment 408 corresponds to a change in the current viewpoint of user 406 relative to environment 404). As a result of the movement of user 406, video content 444 displayed by real-world TV 440 is no longer visible to user 406. In some examples, as shown in FIG. 4H, electronic device 402 maintains presentation of virtual representations 412b-412d in environment 404. For example, virtual representations 412b-412d are presented in environment 404 independent of a location of real-world TV 440 in a head-locked and/or body-locked orientation. In some examples, virtual representations 412b-412d are alternatively presented in different locations in environment 404 in FIG. 4H compared to FIG. 4G (e.g., electronic device 402 presents virtual representations 412b-412d in empty space in environment 404 from the current viewpoint of user 406).

FIG. 4I illustrates an alternative example of FIG. 4H that includes presenting a virtual representation 412e in environment 404 in response to the movement of user 406 to room 424a. In some examples, virtual representation 412e corresponds to a picture-in-picture presentation of video content 444. In some examples, based on the interaction of user 406 with virtual elements 420a-420b in FIGS. 4A-4B and 4E, electronic device 402 determines the intent of user 406 is to present virtual representation 412e in environment 404 when real-world TV 440 (e.g., and video content 444 displayed by real-world TV) is not visible. As shown in FIG. 4I, in response to a change in the current viewpoint of user 406 that causes real-world TV 440 to no longer be visible in environment 404, electronic device 402 presents virtual representation 412e in environment 404. Optionally, electronic device 402 provides an audio output 450 (e.g., represented by schematic sound waves in FIG. 4I) concurrently with presenting virtual representation 412e (e.g., the audio output is synchronized with video content 444 presented by virtual representation 412e). In some examples, when real-world TV 440 is not included in the field-of-view of user 406 and audio is detected from real-world TV 440 (e.g., a threshold amount (e.g., decibels) of audio is detected), electronic device 402 forgoes and/or ceases providing audio output 450. In some examples, virtual representation 412e may be presented in one or more locations in environment 404 as described with reference to virtual representations 414b-414d above (e.g., virtual representation 412e is presented in a location based on default system settings or user settings, and/or virtual representation 412e is movable in environment 404 through user input). In some examples, electronic device 402 ceases to present virtual representation 412e in response to detecting a user input corresponding to a request to cease presentation of virtual representation 412e (e.g., including one or more characteristics of a request to cease presentation of virtual representations 412b-412d described above).

FIG. 4J illustrates electronic device 402 ceasing to present virtual representation 412e in environment 404 in response to movement of user 406 that causes real-world TV 440 to be visible in the user's field of view. As shown in overhead view 410, user 406 has moved in physical environment 408 from room 424a to room 424b. Based on the movement of user 406 from room 424a to room 424b, video content 444 displayed by real-world TV 440 is included in the field-of-view of user 406. In accordance with video content 444 displayed by real-world TV 440 being visible to user 406 and detectable in environment 404, electronic device 402 ceases to present virtual representation 412e in environment 404. In some examples, based on one or more user preferred settings, electronic device 402 does not present content associated with video content 444 when video content 444 is visible to user 406 (e.g., as is shown in FIG. 4J). In some examples, when electronic device 402 ceases to present virtual representation 412e in environment 404, one or more different types of content associated with video content 444 may be displayed in environment 404 (e.g., virtual representations 412a-412d as shown and described with reference to FIGS. 4F-4H). For example, content associated with video content 444 that was presented in environment 404 prior to electronic device 402 presenting virtual representation 412e is presented by electronic device 402 again in environment 404 (e.g., at the same locations in environment 404 from the current viewpoint of user 406). In some examples, electronic device 402 ceases to provide audio output 450 when virtual representation 412e ceases to be presented in environment 404.

It should be appreciated that the content (e.g., virtual representations 312a-312c and 412a-412e) presented (e.g., in environments 304 and 404) in FIGS. 3A-4J are exemplary, and in some examples, content is presented associated with different real-world user interfaces from the real-world user interfaces depicted (e.g., user interfaces of objects different from a microwave and/or a TV). For example, a user of an electronic device (e.g., having one or more characteristics of electronic device 302 and/or 402) interacts with a real-world washing machine, and the electronic device presents a timer in an environment corresponding to a timer displayed by a user interface of the real-world washing machine. For example, the timer is presented by the electronic device when the user is in a region of the physical environment where the washing machine is not located. In another example, a user of an electronic device interacts with website content on a user interface of a laptop and/or mobile device, and, in response to the detected interaction, the electronic device presents information associated with the website content in an environment. For example, the information presented includes supplemental information to the website content. For example, the information is presented in accordance with a field-of-view of the user not including the user interface of the laptop and/or mobile phone (e.g., the electronic device presents the website content in the environment when the user moves to a region of the physical environment where the laptop and/or mobile device are not located).

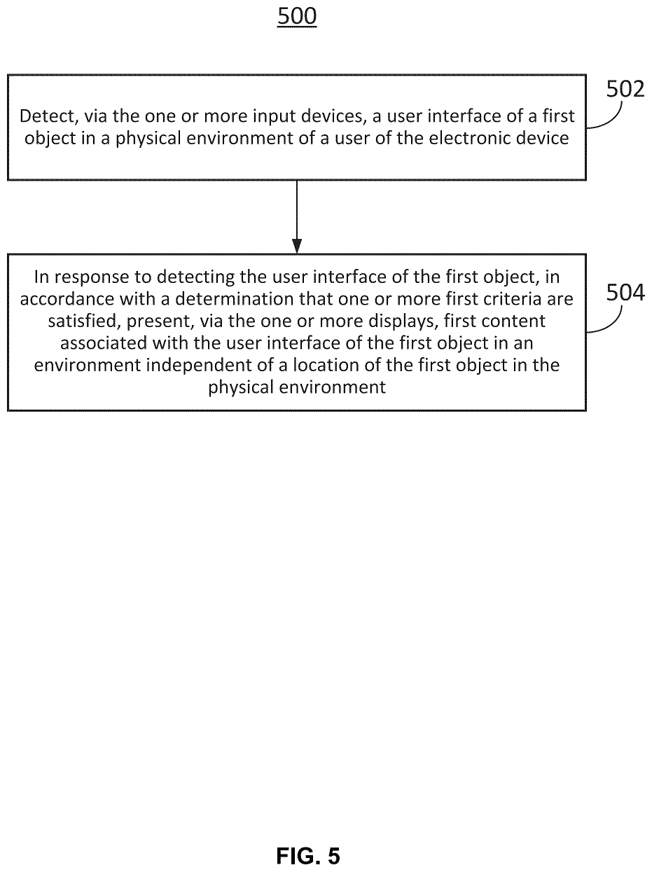

FIG. 5 illustrates a flow diagram of an example process for presenting content in an environment that is associated with a user interface of an object included in a physical environment, according to some examples of the disclosure. In some examples, process 500 begins at an electronic device in communication with one or more displays and one or more input devices. In some examples, electronic device is optionally a head-mounted display similar or corresponding to device 201 of FIG. 2. As shown in FIG. 5, in some examples, at 502, the electronic device detects, via the one or more input devices, a user interface of a first object in a physical environment of a user of the electronic device. For example, as shown in FIG. 3A, electronic device 302 detects a real-world user interface of a real-world object in a physical environment (e.g., real-world user interface 316 of real-world microwave 336 in physical environment 308). For example, as shown in FIG. 4A, electronic device 402 detects a real-world user interface (e.g., a display) of a real-world TV (e.g., real-world TV 440) in a physical environment (e.g., physical environment 408).

In some examples, at 504, in response to detecting the user interface of the first object, in accordance with a determination that one or more first criteria are satisfied, the electronic device presents, via the one or more displays, first content associated with the user interface of the first object in an environment independent of a location of the first object in the physical environment. For example, as shown in FIG. 3C, electronic device 302 presents a virtual representation 312a in environment 304 that includes a timer corresponding to a time interval displayed by real-world user interface 316 in FIG. 3B. For example, as shown in FIG. 4F, electronic device 402 presents a virtual representation 412a in environment 404 corresponding to subtitles associated with video content 444 displayed by real-world TV 440. For example, as shown in FIGS. 4G-4H, electronic device 402 presents virtual representations 412b-412d in environment 404 corresponding to metadata and/or information associated with video content 444 displayed by real-world TV 440. For example, as shown in FIG. 4I, electronic device 402 presents a virtual representation 412e corresponding to a picture-in-picture presentation of video content 444 displayed by real-world TV 440.

In some examples, the one or more criteria include a criterion that is satisfied when the electronic device detects (e.g., and/or determines) that the intent of the user of the electronic device is to interact with the user interface of the first object. For example, in FIGS. 3A-3B, electronic device 302 determines the intent of user 306 is to interact with real-world user interface 316 through the detection of attention (e.g., gaze 318) of user 306 directed to real-world user interface 316 and/or physical interaction of user 306 with real-world user interface 316. For example, in FIG. 4A, electronic device 402 detects the intent of user 406 to interact with real-world TV 440 through the detection of video content 444 displayed by real-world TV 440 and/or attention (e.g., gaze 418) of user 406 directed to real-world TV 440. For example, as shown in FIGS. 4B-4C, electronic device 402 detects the intent of user 406 to interact with real-world TV 440 through the detection of interaction with virtual element 420a and/or virtual element 420b. In some examples, presenting the first content associated with user interface of the first object in the environment independent of a location of the first object in the physical environment includes presenting the first content at a location in the environment that does not correspond to the location of the first object in the environment from the current viewpoint of the user of the electronic device. For example, as shown in FIG. 3B, electronic device 302 presents virtual representation 312a in environment 304 when real-world user interface 316 of real-world microwave 336 is not visible in environment 304 from the current viewpoint of user 306 (e.g., electronic device 302 presents virtual representation 312a in environment 304 when user 306 is a threshold distance from real-world user interface 316 of real-world microwave 336). For example, as shown in FIGS. 4G-4H, electronic device 402 presents virtual representations 412b-412d in environment 404 when real-world TV 440 is visible and when real-world TV 440 is not visible from the current viewpoint of user 406. For example, as shown in FIG. 4I, electronic device 402 presents virtual representation 412e in environment 404 when real-world TV 440 (e.g., and video content 444) is not visible from the current viewpoint of user 406.

It is understood that process 500 is an example and that more, fewer, or different operations can be performed in the same or in a different order. Additionally, the operations in process 500 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising at an electronic device in communication with one or more displays and one or more input devices, detecting, via the one or more input devices, a user interface of a first object in a physical environment of a user of the electronic device. In some examples, the method further comprises, in response to detecting the user interface of the first object, in accordance with a determination that one or more first criteria are satisfied, presenting, via the one or more displays, first content associated with the user interface of the first object in an environment independent of a location of the first object in the physical environment.

Additionally, or alternatively, in some examples, presenting the first content in the environment includes presenting one or more virtual representations in the environment in a first region relative to a current viewpoint of the user, wherein the first region relative to the current viewpoint of the user is independent of a location of the first object relative to the current viewpoint of the user.

Additionally, or alternatively, in some examples, the one or more virtual representations are presented in the environment in accordance with a determination that a field of view of the environment does not include the user interface of the first object from the current viewpoint of the user.

Additionally, or alternatively, in some examples, the one or more virtual representations are presented in the environment in accordance with a determination that the user interface of the first object is outside of a threshold distance from a location corresponding to the current viewpoint of the user in the environment.

Additionally, or alternatively, in some examples, the one or more first criteria include a criterion that is satisfied when, when the user interface of the first object is detected, intent of the user to interact with the user interface of the first object is detected.

Additionally, or alternatively, in some examples, detecting the intent of the user to interact with the user interface of the first object includes detecting an input directed to the user interface of the first object.

Additionally, or alternatively, in some examples, detecting the intent of the user to interact with the user interface of the first object includes: after detecting the input directed to the user interface of the first object, presenting a virtual element in the environment that is interactive to present the first content in the environment; and detecting, via the one or more input devices, an input corresponding to user interaction with the virtual element.

Additionally, or alternatively, in some examples, the one or more first criteria include a criterion that is satisfied when one or more settings associated with the first content stored in a user profile have a first status and the criterion is not satisfied when the one or more settings associated with the first content stored in the user profile have a second status, different from the first status.

Additionally, or alternatively, in some examples, the one or more first criteria include a criterion that is satisfied when a mode of operation that includes presenting content in the environment associated with one or more objects included in the physical environment is currently active.

Additionally, or alternatively, in some examples, presenting the first content in the environment includes: during a first time period, storing information associated with the user interface of the first object without presenting a first virtual representation associated with the user interface of the first object in the environment; and during a second time period after the first time period, presenting, via the one or more displays, one or more virtual representations associated with the user interface of the first object in the environment based on the stored information.

Additionally, or alternatively, in some examples, presenting the first content in the environment includes presenting the first content in a system user interface of the electronic device.

Additionally, or alternatively, in some examples, the user interface of the first object includes a timer set to a first time interval in the physical environment, and the first content presented in the environment includes a timer set to the first time interval.

Additionally, or alternatively, in some examples, the user interface of the first object includes video content that is displayed via a physical display in the physical environment, and the first content includes information corresponding to the video content.

Additionally, or alternatively, in some examples, presenting the first content in the environment includes presenting supplemental content associated with the video content.

Additionally, or alternatively, in some examples, presenting the first content in the environment includes outputting audio associated with the video content to the user.

Additionally, or alternatively, in some examples, presenting the first content in the environment includes presenting a picture-in-picture view of the video content.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method, comprising:
at an electronic device in communication with one or more displays and one or more input devices:
detecting, via the one or more input devices, a user interface of a first object in a physical environment of a user of the electronic device; and
in response to detecting the user interface of the first object, in accordance with a determination that one or more first criteria are satisfied, presenting, via the one or more displays, first content associated with the user interface of the first object in an environment independent of a location of the first object in the physical environment.

2. The method of claim 1, wherein presenting the first content in the environment includes presenting one or more virtual representations in the environment in a first region relative to a current viewpoint of the user, wherein the first region relative to the current viewpoint of the user is independent of a location of the first object relative to the current viewpoint of the user.

3. The method of claim 2, wherein the one or more virtual representations are presented in the environment in accordance with a determination that a field of view of the environment does not include the user interface of the first object from the current viewpoint of the user.

4. The method of claim 2, wherein the one or more virtual representations are presented in the environment in accordance with a determination that the user interface of the first object is outside of a threshold distance from a location corresponding to the current viewpoint of the user in the environment.

5. The method of claim 1, wherein the one or more first criteria include a criterion that is satisfied when, when the user interface of the first object is detected, intent of the user to interact with the user interface of the first object is detected.

6. The method of claim 5, wherein detecting the intent of the user to interact with the user interface of the first object includes detecting an input directed to the user interface of the first object.

7. The method of claim 6, wherein detecting the intent of the user to interact with the user interface of the first object includes:
after detecting the input directed to the user interface of the first object, presenting a virtual element in the environment that is interactive to present the first content in the environment; and
detecting, via the one or more input devices, an input corresponding to user interaction with the virtual element.

8. The method of claim 1, wherein presenting the first content in the environment includes:
during a first time period, storing information associated with the user interface of the first object without presenting a first virtual representation associated with the user interface of the first object in the environment; and
during a second time period after the first time period, presenting, via the one or more displays, one or more virtual representations associated with the user interface of the first object in the environment based on the stored information.

9. An electronic device comprising:
one or more processors;
memory; and
one or more programs stored in the memory and configured to be executed by the one or more processors, the one or more programs including instructions for performing a method comprising:
detecting, via one or more input devices, a user interface of a first object in a physical environment of a user of the electronic device; and
in response to detecting the user interface of the first object, in accordance with a determination that one or more first criteria are satisfied, presenting, via one or more displays, first content associated with the user interface of the first object in an environment independent of a location of the first object in the physical environment.

10. The electronic device of claim 9, wherein presenting the first content in the environment includes presenting one or more virtual representations in the environment in a first region relative to a current viewpoint of the user, wherein the first region relative to the current viewpoint of the user is independent of a location of the first object relative to the current viewpoint of the user.

11. The electronic device of claim 10, wherein the one or more virtual representations are presented in the environment in accordance with a determination that a field of view of the environment does not include the user interface of the first object from the current viewpoint of the user.

12. The electronic device of claim 10, wherein the one or more virtual representations are presented in the environment in accordance with a determination that the user interface of the first object is outside of a threshold distance from a location corresponding to the current viewpoint of the user in the environment.

13. The electronic device of claim 9, wherein the one or more first criteria include a criterion that is satisfied when, when the user interface of the first object is detected, intent of the user to interact with the user interface of the first object is detected.

14. The electronic device of claim 13, wherein detecting the intent of the user to interact with the user interface of the first object includes detecting an input directed to the user interface of the first object.

15. The electronic device of claim 14, wherein detecting the intent of the user to interact with the user interface of the first object includes:
after detecting the input directed to the user interface of the first object, presenting a virtual element in the environment that is interactive to present the first content in the environment; and
detecting, via the one or more input devices, an input corresponding to user interaction with the virtual element.

16. The electronic device of claim 9, wherein presenting the first content in the environment includes:
during a first time period, storing information associated with the user interface of the first object without presenting a first virtual representation associated with the user interface of the first object in the environment; and
during a second time period after the first time period, presenting, via the one or more displays, one or more virtual representations associated with the user interface of the first object in the environment based on the stored information.

17. A non-transitory computer readable storage medium storing one or more programs, the one or more programs comprising instructions, which when executed by one or more processors of an electronic device, cause the electronic device to perform a method comprising:
detecting, via one or more input devices, a user interface of a first object in a physical environment of a user of the electronic device; and
in response to detecting the user interface of the first object, in accordance with a determination that one or more first criteria are satisfied, presenting, via one or more displays, first content associated with the user interface of the first object in an environment independent of a location of the first object in the physical environment.

18. The non-transitory computer readable storage medium of claim 17, wherein presenting the first content in the environment includes presenting one or more virtual representations in the environment in a first region relative to a current viewpoint of the user, wherein the first region relative to the current viewpoint of the user is independent of a location of the first object relative to the current viewpoint of the user.

19. The non-transitory computer readable storage medium of claim 18, wherein the one or more virtual representations are presented in the environment in accordance with a determination that a field of view of the environment does not include the user interface of the first object from the current viewpoint of the user.

20. The non-transitory computer readable storage medium of claim 18, wherein the one or more virtual representations are presented in the environment in accordance with a determination that the user interface of the first object is outside of a threshold distance from a location corresponding to the current viewpoint of the user in the environment.

21. The non-transitory computer readable storage medium of claim 17, wherein the one or more first criteria include a criterion that is satisfied when, when the user interface of the first object is detected, intent of the user to interact with the user interface of the first object is detected.

22. The non-transitory computer readable storage medium of claim 21, wherein detecting the intent of the user to interact with the user interface of the first object includes detecting an input directed to the user interface of the first object.

23. The non-transitory computer readable storage medium of claim 22, wherein detecting the intent of the user to interact with the user interface of the first object includes:
after detecting the input directed to the user interface of the first object, presenting a virtual element in the environment that is interactive to present the first content in the environment; and
detecting, via the one or more input devices, an input corresponding to user interaction with the virtual element.

24. The non-transitory computer readable storage medium of claim 17, wherein presenting the first content in the environment includes:
during a first time period, storing information associated with the user interface of the first object without presenting a first virtual representation associated with the user interface of the first object in the environment; and
during a second time period after the first time period, presenting, via the one or more displays, one or more virtual representations associated with the user interface of the first object in the environment based on the stored information.
